(19) United States
(12) Patent Application Publication
(10) Pub. No.: US 2011/0131494 A1
(43) Pub. Date: Jun. 2, 2011

(54) INFORMATION PROCESSING APPARATUS, AUDIO APPARATUS, AND INFORMATION PROCESSING METHOD

(75) Inventors: Takatsugu ONO, Kobe-shi (JP); Noriyuki KAMIKAWA, Kobe-shi (JP); Tatsuki KUBO, Kobe-shi (JP)

(73) Assignee: FUJITSU TEN LIMITED, KOBE-SHI (JP)

(21) Appl. No.: 12/956,085

(22) Filed: Nov. 30, 2010

(30) Foreign Application Priority Data
Nov. 30, 2009 (JP) 2009-271713

(51) Int. Cl. G06F 3/048

(52) U.S. Cl. 715/716; 715/810

(57) ABSTRACT

An information processing apparatus is provided. An item selection device selects, through a selection manipulation unit, an item from a plurality of items which are displayed in the form of a list and arranged in an arrangement direction. A manipulation detection unit detects a state of a selection manipulation of the selection manipulation unit. A display area enlargement unit enlarges a display area of the selected item in the arrangement direction when the manipulation detection unit detects that the selection manipulation of the selection manipulation unit is stopped.

The disclosure of Japanese Patent Application No. 2009-271713 filed on Nov. 30, 2009, including specification, drawings and claims is incorporated herein by reference in its entirety.

### BACKGROUND

The present invention relates to a manipulation device for performing manipulation of an appliance, and more particularly to a manipulation device which is suitable for a vehicle-mounted appliance and the like and selects a corresponding item from a plurality of items.

A vehicle-mounted appliance has long been multifunctional, and one appliance has diverse kinds of content, for example, functions of a TV, radio receiver, CD, HDD, DVD, navigation, and the like. For example, a user in a vehicle can watch the TV, and also can watch or listen to content such as the CD or radio receiver while he/she is guided by a navigation function whilst driving. With such a multifunctional vehicle-mounted appliance, the method of manipulating the appliance also becomes complicated, and diverse functions and manipulation items according to each content are displayed in the form of a list. As a frequently used manipulation method, a user selects a desired function/manipulation item from the list of content, and thus the corresponding function/manipulation item selectively starts to operate. For example, Patent Document 1 discloses a technique of manipulating a vehicle-mounted appliance by performing a selection of a plurality of contents and items included in the content.

In the related art, in the case of selecting a desired item from a plurality of items, it is possible to see a large amount of information about one display screen through a display of many selection items on the display screen. Also, in the case of displaying a large number of items on one screen, the number of display screen switching operations is reduced, and thus it is not necessary to repeat the performing of the display switching operation several times whilst driving. Also, the number of times a user views the switched screen is also reduced.

However, since the vehicle-mounted appliance is limited by the area it is mounted in, the size of a display that displays information that is necessary for manipulation is restricted. Accordingly, in the case of displaying many items on one display screen, the display items being displayed are concentrated, and a display area of one item and displayed text becomes smaller causing the visibility of each item to deteriorate. Also, as the amount of information that can be displayed for one item becomes smaller, the information for a user to determine whether to select or not may be missing from the display screen.

In contrast, if the number of items for one screen is reduced to enlarge the display area when items are selected in order to increase the visibility, the amount of information that can be displayed on the display area for one item becomes larger, and thus the visibility can be improved. However, since the number of items displayed on one display screen becomes smaller, a user has to perform the display screen switching operation several times in order to confirm many items. For example, if it is assumed that the number of selection items is 100 and the number of items that can be displayed on one display screen is 5, it is necessary to change the manipulation screen 20 times, and this may cause the user great inconvenience.

Patent Document 1: JP-A-2004-022179

### SUMMARY

It is therefore an object of at least one embodiment of the present invention to realize an improvement in the visibility and manipulability of a selection display screen in manipulating item selection.

In order to achieve at least one of the above-described objects, according to a first aspect of the embodiments of the present invention, there is provided an information processing apparatus comprising an item selection device that selects, through a selection manipulation unit, an item from a plurality of items which are displayed in the form of a list and arranged in an arrangement direction, the item selection device including: a manipulation detection unit that detects a state of a selection manipulation of the selection manipulation unit; and a display area enlargement unit that enlarges a display area of the selected item in the arrangement direction when the manipulation detection unit detects that the selection manipulation of the selection manipulation unit is stopped.

For example, in a device in which titles of a plurality of music pieces to be selected are displayed in the form of a list and a user selects a candidate music piece in the list through a selection manipulation of the selection manipulation unit, if the user stops the selection manipulation for changing the candidate music piece, it is assumed that the user desires to confirm the contents of the candidate music piece, and thus text is enlarged through widening of the display area or detailed information is displayed to improve the visibility, the amount of information being displayed, and the like.

The selection manipulation unit may be a rotary manipulation unit which selects an item by a rotating manipulation.

For example, in a device in which the candidate music piece is changed in a sequential list through the rotating manipulation of the rotary manipulation unit, if the candidate music piece is changed at a speed that follows the rotating manipulation speed and the rotation stops, the text is enlarged through widening of the display area of the candidate music piece at that time or the detailed information is displayed to improve the manipulability and visibility for selecting a music piece.

The manipulation detection unit may detect that the selection manipulation of the selection manipulation unit is stopped by a non-detection time of the selection manipulation in the selection manipulation unit.

For example, in a device in which the candidate music piece is changed in a sequential list through the rotating manipulation of the rotary manipulation unit, if a signal that indicates the rotation is not output for a predetermined time, it is determined that the rotating manipulation has been stopped, and the rotation stop which has no relation to the user's intention to confirm the candidate music piece under the manipulation circumstances (when the required rotation number cannot be obtained at a time such as greatly moving the candidate music piece, and the like) is excluded, thereby improving the accuracy of the assumption that the user desires to confirm the candidate music piece.

The information processing apparatus may further comprise a detailed information display unit that displays detailed information about the selected item on the display area of the selected item when the manipulation detection unit detects that the selection manipulation of the selection manipulation unit is stopped.

For example, in a device in which the candidate music piece is changed in a sequential list through the rotating manipulation of the rotary manipulation unit, the user's confirmation of the candidate music piece can be easily and certainly performed by estimating the user's intention to confirm the candidate music piece from the stop of the rotating manipulation and displaying the detailed information about the candidate music piece.

The display area enlargement unit may enlarge the display area of the selected item in accordance with the amount of the detailed information displayed by the detailed information display unit.

For example, in a device in which the candidate music piece is changed in a sequential list through the rotating manipulation of the rotary manipulation unit, the user's confirmation of the candidate music piece can be easily and certainly performed by making it possible to estimate the user's intention to confirm the candidate music piece from the stop of the rotating manipulation and displaying the detailed information about the candidate music piece or enlarging the size of the text.

The display area enlargement unit may enlarge the display area of the selected item in accordance with the number of items of the detailed information displayed by the detailed information display unit.

For example, in a device in which the candidate music piece is changed in a sequential list through the rotating manipulation of the rotary manipulation unit, information about the corresponding candidate music piece and information about the other music pieces is efficiently displayed and the user's confirmation of the candidate music piece or the other music pieces can be easily and certainly performed by estimating the user's intention to confirm the candidate music piece from the stop of the rotating manipulation and varying the width of the display area in accordance with the amount of information about the detailed information that the candidate music piece has.

The display area enlargement unit may select whether to enlarge the display area of the selected item in accordance with a hierarchy of items of the detailed information displayed by the detailed information display unit.

For example, if an upper hierarchy is a genre of a music piece and a lower hierarchy is title of the music piece, detailed information about the genre is not so necessary, and it is convenient to increase the number of displayed genres rather than to display the detailed information about the candidate genre. By contrast, with respect to the title of the music piece, it is frequently desired to confirm the detailed information thereof. As described above, since the necessity of the detailed information differs according to the hierarchy, whether to enlarge the display area of the candidate item is set according to the necessity, and thus manipulability of the user's selection manipulation is improved.

The information processing apparatus may further comprise a text size varying unit that varies a size of a text which is displayed on the display area of the selected item in accordance with a size of the display area of the selected item.

For example, by enlarging the size of the displayed text in accordance with the size of the display area of the candidate music piece, information about the corresponding candidate music piece and information about the other music pieces are displayed to be easily seen, and the user's confirmation of the candidate music piece or the other music pieces can be easily and certainly performed.

The items may be displayed such that display areas of the items gradually become smaller as it is getting out of the selected item.

For example, the closer the display area is to the display area of the candidate music piece, the larger the display area is, and thus enlargement of the size of the displayed text becomes possible. Accordingly, it becomes easier to select the corresponding candidate music piece. Particularly, in the case of the selection by the rotating manipulation, it becomes easy to obtain the stop time of the rotating manipulation, and thus manipulability is greatly improved.

The information processing apparatus may further comprise a position display unit that displays position relationship of the selected item with respect to all of the items in the list.

For example, by displaying a mark on a position according to a recording order of the whole music pieces to be selected among the music pieces being selected in a scroll bar having a length according to the whole number of music pieces to be selected, it can be grasped which position in the whole range of the music pieces to be selected the candidate music piece being selected is in, and in the case where the brief position of the desired music piece is grasped, the desired music piece can be promptly found to greatly improve the search manipulability.

The items may be displayed in a cyclic manner that first to n-th items are sequentially displayed by the selection manipulation of the selection manipulation unit, the n-th item is followed by the first item when the selection manipulation is in a forward direction, and the first item is followed by the nth item when the selection manipulation is in a backward direction.

For example, in the case of switching to the last music piece during listening to the forefront music piece, an immediate selection of the music piece is possible by the moving manipulation in the backward direction of the recording order, and thus the music piece selection manipulation can be greatly improved.

The information processing apparatus may further comprise a boundary line display unit that displays a boundary line between the first item and the n-th item.

For example, by displaying the boundary line between the forefront music piece and the last music piece in the music piece list, the user can grasp the position of the forefront or last music piece, and thus the search manipulability in selecting the music piece can be greatly improved.

The information processing apparatus may further comprise: a selection decision unit that makes the selected item in a selection decided state; an operation control unit that makes a controlled appliance in an operation state corresponding to selected item in the selection decided state; a storage unit that stores the operation state of the controlled appliance; a return control unit that reads the operation state of the controlled appliance from the storage and makes the controlled appliance return to the operation state when; and a return manipulation unit that performs an instruction to make the controlled appliance return to the operation state stored in the storage unit; and a return control unit that reads the operation state stored in the storage unit and makes the controlled appliance return to the operation state when the instruction is performed by the return manipulation unit.

For example, in the case where a channel selection manipulation is performed to listen to an AM radio broadcast during reproduction of music by the HD reproduction device, but no favorable program is found, it is frequently wanted to return to the original music reproduction state, but it requires a complicated music selection manipulation. Accordingly, by a simple manipulation that is called a “return button” manipulation, it is possible to return to the original music reproduction state, and thus manipulability is improved.

The information processing apparatus may further comprise: an upper hierarchy display unit that displays an upper hierarchy item which are an item of an upper hierarchy; a lower hierarchy display unit that displays lower hierarchy items which are items of a lower hierarchy corresponding to the upper hierarchy item displayed by the upper hierarchy display unit, as the items displayed in the form of the list; and an upper hierarchy change detection unit that detects a changing manipulation for changing the upper hierarchy item, wherein when the upper hierarchy change detection unit detects the changing manipulation, the upper hierarchy display unit displays the changed upper hierarchy item and the lower hierarchy display unit displays lower hierarchy items corresponding to the changed upper hierarchy item.

For example, the upper hierarchy can be directly changed without moving the upper hierarchy to the lower hierarchy, and in the ease of changing the upper hierarchy to the lower hierarchy, the lower hierarchy is also changed to a lower hierarchy that follows the corresponding upper hierarchy (for example, it is preferable to restore the upper hierarchy to the state of the lower hierarchy at the latest time for the corresponding previous items). Accordingly, the change manipulation of the upper hierarchy is facilitated, and the manipulation state also becomes appropriate according to the upper hierarchy selection state to improve manipulability.

The upper hierarchy change detection unit may detect a slide manipulation of the selection manipulation unit.

For example, the items of the upper hierarchy are changed by the slide manipulation of the rotary manipulation unit in an upward/downward direction (a direction that is orthogonal to the hierarchy arrangement), and thus the manipulation coincides with the manipulator's manipulation sense to improve the manipulation easiness. Also, the manipulation can be made without taking a hand off the lower hierarchy manipulation, and thus manipulability is improved.

The upper hierarchy change detection unit may include: a hierarchy movement manipulation detection unit that detects a direction of the slide manipulation of the selection manipulation unit; and a hierarchy movement unit that moves hierarchy of the items displayed in the form of the list in accordance with the direction of the slide manipulation, detected by the hierarchy movement manipulation detection unit.

For example, the items of the upper hierarchy move to the lower hierarchy by the slide manipulation of the rotary manipulation unit in a left/right direction (a direction of the hierarchy line) and the corresponding items are displayed as a list. Accordingly, the items of the upper hierarchy can be selected by the rotating manipulation, and thus manipulability is improved.

According to a second aspect of the embodiments of the present invention, there is provided an audio apparatus comprising an item selection device that selects, through a selection manipulation unit, music piece information from a plurality of music piece information which are displayed in the form of a list and arrange in an arrangement direction, the selection device including: a manipulation detection unit that detects a state of a selection manipulation of the selection manipulation unit; and a display area enlargement unit that enlarges a display area of the selected music piece information in the arrangement direction when the manipulation detection unit detects that the selection manipulation of the selection manipulation unit is stopped.

For example, in a device in which titles of a plurality of music pieces to be selected are displayed in the form of a list and a user selects candidate music pieces in the list through a manipulation of the selection manipulation unit, if the user stops the manipulation for changing the candidate music pieces, it is assumed that the user desires to confirm the contents of the candidate music pieces, and thus the text is enlarged through widening of the display area or detailed information is displayed to improve the visibility, the amount of information being displayed, and the like.

The audio apparatus may further comprise: a decision manipulation detection unit that detects a decision manipulation which makes the selected music piece information in a selection decided state; and a decided music piece reproduction unit that reproduces a music piece corresponding to the selected music piece information in the selection decided state.

For example, by maintaining the original music piece reproduction state when a user performs change manipulation of a candidate music piece and first starting the reproduction of the candidate music piece by performing the decision manipulation, an equivocal music piece reproduction in the middle of the change manipulation is suppressed, and thus a state where a user feels unpleasant is prevented from occurring.

The audio apparatus may further comprise a selected music piece reproduction unit that reproduces a music piece corresponding to the selected music piece information.

For example, when a user performs a change manipulation of the candidate music piece, the decision manipulation is not necessary, and by immediately reproducing the music piece that is in a change manipulation selection state of the candidate music piece, the manipulation can be simplified even in the case where a user searches for a desired music piece while seeing a portion of the music piece.

The selection manipulation unit may be a rotary manipulation unit which selects music piece information by a rotating manipulation, the audio apparatus may further comprise a rotating speed detection unit that detects a rotating speed of the rotating manipulation of the rotary manipulation unit, and when the rotating speed detected by the rotating speed detection unit is higher than a predetermined value, the selected music piece reproduction unit may skip a predetermined number of music pieces.

For example, if the user performs the change manipulation of the candidate music pieces at a high speed, for example, through skipping over 5 music pieces, the reproduction of the respective music pieces for a very short time, to which the listening is of no use, can be prevented, and thus a practical manipulation support function can be realized in searching for the music pieces.

The audio apparatus may further comprise: a music piece reproduction unit that reproduces a music piece; and a music piece change detection unit that detects a change of the music piece being reproduced by the music piece reproduction unit, wherein when the music piece change detection unit detects the change of the music piece being reproduced, music piece information corresponding to the music piece being reproduced may be displayed in a manner of the selected music piece information.

For example, if the reproduced music piece is changed if the reproduced music piece is switched to the next music piece after the reproduction of the previous music piece has ended, the music piece information that is displayed in a selected state is changed to that of the music piece being reproduced, and thus the currently reproduced music piece information can be immediately confirmed. Also, in the case of performing the change manipulation of the candidate music piece, the music piece search manipulation can be performed based on the currently reproduced music piece, and thus the information providing and manipulability can be improved.

The audio apparatus may further comprise: a reproduction history storing unit that stores reproduction history of music pieces; and a historic order reproduction unit that reproduces the music pieces in the reproduction history stored in the reproduction history storing unit in a historic order from a music piece selected by the selection manipulation unit.

For example, by making it possible to perform music selection manipulation in due order based on the reproduction history order, such as returning to the music piece reproduced before the currently reproduced music piece, the manipulation which wholly gratifies the user's sense can be realized.

According to a third aspect of the embodiments of the present invention, there is provided an item selection method for selecting, through a selection manipulation unit, an item from a plurality of items which are displayed in the form of a list and arranged in an arrangement direction, the item selection method comprising: detecting a state of a selection manipulation of the selection manipulation unit; and enlarging a display area of the selected item in the arrangement direction when detecting that the selection manipulation of the selection manipulation unit is stopped.

For example, in a device in which titles of a plurality of music pieces to be selected are displayed in the form of a list and a user selects candidate music pieces in the list through the manipulation of the selection manipulation unit, if the user stops the manipulation for changing the candidate music pieces, it is assumed that the user desires to confirm the contents of the candidate music pieces, and thus text is enlarged through the widening of the display area or detailed information is displayed to improve the visibility, the amount of information being displayed, and the like.

According to the present invention, for example, with respect to an appliance having an audio function and a navigation function or the like, a user's convenience in use can be improved.

### BRIEF DESCRIPTION OF THE DRAWINGS

In the accompanying drawings:

FIG. 1 is a block diagram illustrating the configuration of an AVN integrated appliance;

FIGS. 2A to 2D are schematic views illustrating the construction of a remote manipulation unit;

FIGS. 3A and 3B are schematic diagrams of a form screen;

FIG. 4 is a schematic diagram of a menu screen;

FIG. 5 is a schematic diagram of an HDD manipulation screen;

FIG. 6 is a schematic diagram of an album search manipulation screen;

FIG. 7 is a schematic diagram of a music piece selection manipulation screen;

FIG. 8 is a schematic diagram of a “My Best” search manipulation screen;

FIG. 9 is a schematic diagram of a music piece title display enlargement screen;

FIG. 10 is a schematic diagram of a navigation manipulation screen;

FIG. 11 is a schematic diagram of a function display enlargement screen;

FIG. 12 is a flowchart illustrating an enlargement display process;

FIG. 13 is a flowchart illustrating a pressing manipulation music reproduction process;

FIGS. 14A to 14C are flowcharts illustrating a music piece selection manipulation process;

FIGS. 15A and 15B are flowcharts illustrating a “return” manipulation process;

FIG. 16 is a schematic diagram of a historic order music piece selection manipulation screen;

FIG. 17 is a diagram illustrating a display type indicating a positional relationship in the whole list of the selected item;

FIG. 18 is a view illustrating a steering wheel on which a remote manipulation unit is installed;

FIG. 19 is a diagram illustrating a preferential display type of an image preferential display; and

FIGS. 20A and 20B are diagrams illustrating a preferential display type of an area preferential display.

### DETAILED DESCRIPTION OF THE EMBODIMENTS

A vehicle-mounted audio/visual/navigation integrated appliance (hereinafter referred to as an “AVN integrated appliance”) according to an embodiment of the present invention will be described hereinafter.

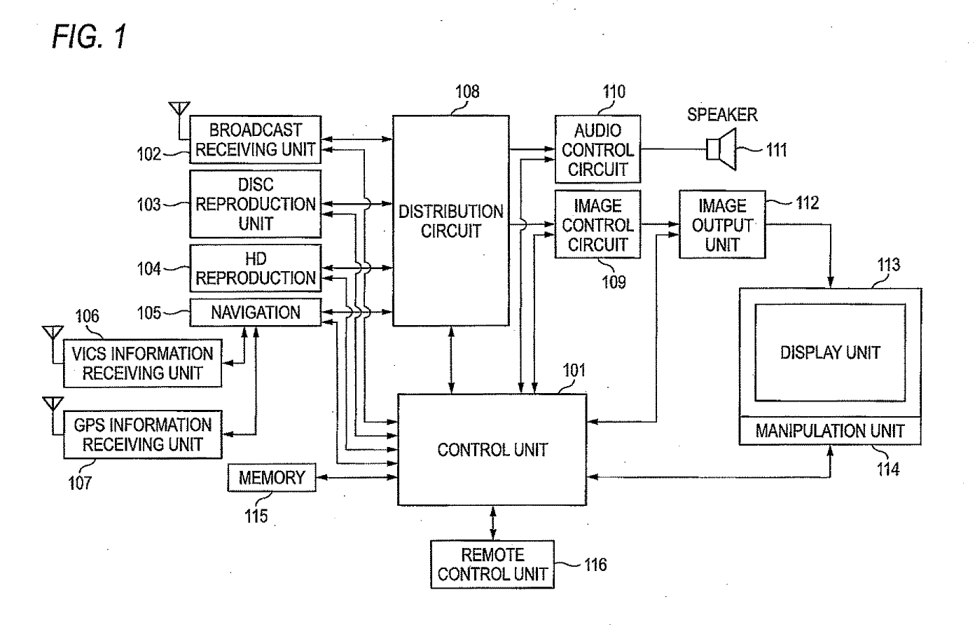

FIG. 1 is a block diagram illustrating the configuration of an AVN integrated appliance according to an embodiment of the present invention, “101” denotes a control unit which receives input signals from respective units of the AVN integrated appliance or an external appliance connected thereto and manipulation indication signals from respective manipulation units based on a user's manipulation, and generally controls the respective units of the AVN integrated appliance or the external appliance based on the signals. For example, the control unit is configured by a microcomputer, and operates according to a program stored in a memory such as a ROM or the like.

“102” denotes a broadcast receiving unit which selectively receives a broadcast wave of a specified frequency from broadcast waves received by an antenna, modulates and outputs an audio signal and an image signal (in the case of a television broadcast) of the corresponding broadcast. The broadcast receiving unit is composed of a tuning circuit, demodulation/decoding circuit, and the like. Various kinds of operations of the broadcast receiving unit, such as an on/off operation, received frequency, and the like, are controlled by control signals from the control unit 101. “103” denotes a disc reproduction unit which reads data stored in a disc through a pickup, and outputs audio/image signals (for example, in the case of a DVD or BD (Blu-ray Disc)) based on the read data. The disc reproduction unit is composed of an optical pickup, a pickup/disc driving mechanism, a control circuit of the pickup/disc driving mechanism, a decoding circuit of the read signal, and the like. Various kinds of operations of the disc reproduction unit 103, such as an on/off operation, reading position, and the like, are controlled by control signals from the control unit 101.

“104” denotes an HD reproduction unit which stores music data such as MP3 files, image data such as PEG files, map data for navigation, and the like, in a hard disc (HD) that is a magnetic recording medium, reads desired data from various kinds of data stored, and outputs an image signal, an audio signal, and a text signal. The HD reproduction unit is composed of an HD drive, a decoding circuit of a read signal, and the like. Various kinds of operations of the HD reproduction unit 104, such as an on/off operation, data to be read, and the like, are controlled by control signals from the control unit 101.

“105” denotes a navigation unit which guides a path to a destination by displaying a vehicle position or a path to the destination on a map, guiding a traveling direction such as left/right turn or the like by voice or the like at an intersection, obtaining and displaying traffic information from a VICS information receiving unit 106 and vehicle position information from a GPS information receiving unit 107 to be described later. The navigation unit is composed of a hard disc (HD) that stores map information that is used for navigation, a CPU that performs various kinds of operations, and a memory such as a RAM for storing data for various kinds of processes. Various kinds of operations of the navigation unit such as an on/off operation or the like are controlled by control signals from the control unit 101.

“106” denotes a VICS information receiving unit which receives traffic information about VICS (Vehicle Information & Communication System) (registered mark) and outputs the received traffic information. The VICS receiving unit is composed of receivers (FM receiver, radio wave beacon receiver, and optical beacon receiver) receiving data from the VICS, a decoding circuit that decodes the received data, and the like. “107” denotes a GPS information receiving unit which detects a vehicle position based on a GPS signal from a GPS (registered mark) satellite and outputs the detected present position information. The GPS information receiving unit is composed of a GPS signal receiving circuit that receives the GPS signal, and an operation unit that calculates the vehicle position based on the received GPS signal.

“108” denotes a distribution circuit which outputs audio signals and image signals from various kinds of sources (the disc reproduction unit 103, the broadcast receiving unit 102, the HD reproduction unit 104, and the navigation unit 105), the outputs of which are designated by the control signals of the control unit 101, to an audio control circuit 110 and an image control circuit 109. The distribution circuit is composed of a switch group having electronic circuits such as relays or switching transistors. “109” denotes an image control circuit which controls luminance, color tone, contrast, and the like, of the input image signal and outputs a controlled image signal by the control signal of the control unit 101. The image control circuit is composed of a memory storing image data, an operation circuit such as a digital signal processor or the like that performs an operation of the image data, and the like.

“110” denotes an audio control circuit which controls the volume and audio of the input audio signal and outputs a controlled audio signal by the control signal of the control unit 101. The audio control circuit is composed of a memory storing audio data, an operation circuit such as a digital signal processor that performs operation of the image data, an amplification/attenuation circuit or a resonance circuit having transistors, resistors, capacitors, and coils. “111” denotes a speaker that outputs the audio signal input by the audio control circuit 110.

“112” denotes an image output unit which receives an input image signal from the image control unit and a display image signal for being displayed on a display unit from the control unit 101, performs image synthesis or the like, and drives the display unit 113 based on the processed image signal. For example, the image output unit is composed of an image ASIC which is an operation processing circuit that is specialized to perform an image process by an operation process, a video memory that stores image data for processing/outputting an image, and an image driving circuit that drives the display unit based on the image data stored in the video memory for outputting an image. “113” denotes the display unit that displays an image based on an image signal input by the image output unit 112, and may be composed of, for example, a liquid crystal display, an organic EL display, a plasma display, a cold cathode flat panel display, or the like.

“114” denotes a manipulation unit for a user of the apparatus to perform various kinds of manipulations. The manipulation unit is composed of, for example, a touch panel, a push button switch, rotary manipulation switch, joystick, and the like. “115” denotes a memory (recording medium) for storing various kinds of data or a control program. For example, the memory is made of a HDD (Hard Disc Drive), a rewritable flash memory, or the like. “116” denotes a remote control unit which is installed in a place that is apart from the main body of the AVN integrated appliance body installed on an instrument panel or the like of the vehicle, for example, around an elbow rest between a driver's seat and a passenger seat or on a steering wheel, to output a user's input manipulation state. In this embodiment, the remote control unit detects a rotating manipulation, a tilt manipulation, and pressing manipulation of the manipulation unit. In this case, the remote manipulation unit is composed of a rotary encoder that outputs signals according to the rotating manipulation amount and direction, a tilt sensor composed of a pressure-sensitive sensor, such as a joystick or the like, to output signals according a tilt manipulation direction, and a pressing switch of which the on/off state is changed by the pressing manipulation.

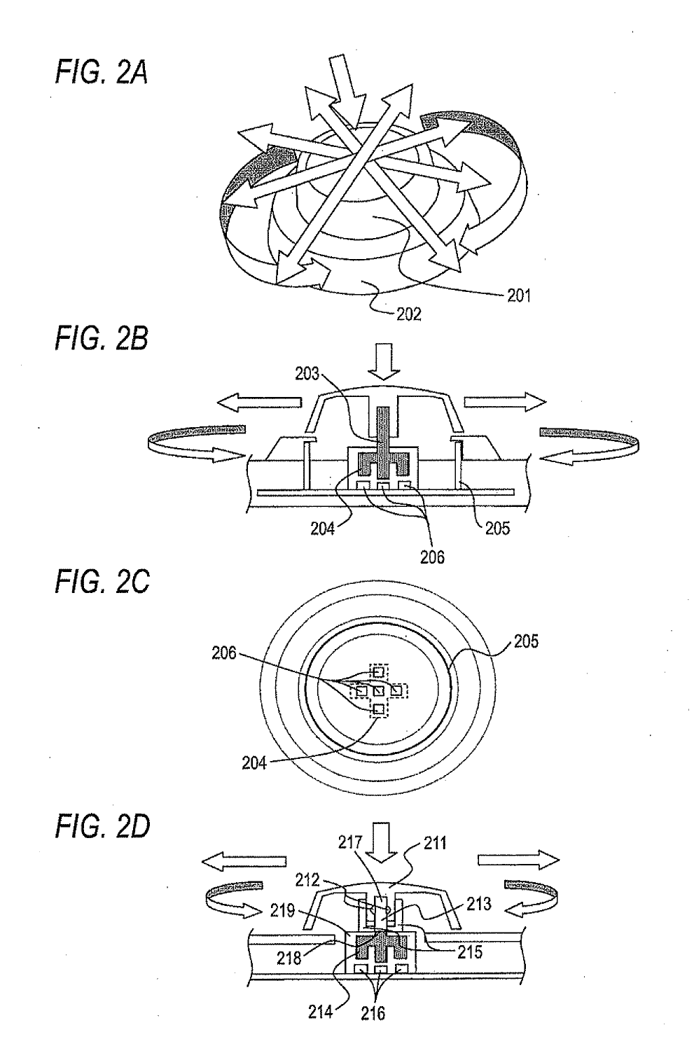

Specifically, for example, the structure of the remote manipulation unit is illustrated in FIGS. 2A to 2D. FIG. 2A is a perspective view of the remote manipulation unit 116 as illustrated in FIG. 1. As illustrated, the remote manipulation unit 116 can perform a pressing manipulation that performs a decision manipulation by the movement of an inner handle 201 in a center axis direction, a tilt manipulation that performs a hierarchy movement or hierarchy change by the movement of the inner handle 201 in 8 vertical directions of the center axis, and a rotating manipulation that performs the selection manipulation by the rotation of an outer handle 202 around the center axis (a clockwise rotation is referred to as a forward rotation and a counterclockwise rotation is referred to as a backward rotation).

Also, FIG. 2B is a schematic plan view of the structure of the remote manipulation unit 116, and FIG. 2C is a schematic plan view of a detection portion of the remote manipulation unit 116. The inner handle 201 is attached to an operation shaft 203 of a switch unit that detects the pressing manipulation and the tilt manipulation. In the switch unit, the operation shaft 203 is installed, which extends in the pressing manipulation direction and is fixed to a switch chassis (fixed to a printed circuit board) so that it can somewhat elastically move with an elastic material such as rubber, and at the other end of the operation shaft 203, an operation piece 204 that spreads out crosswise is installed. Also, on respective end portions and the center portion of the operation piece 204, pressing protrusions are formed to press a switch 206 which is installed on the printed circuit board that is positioned below the operation piece. Also, the outer handle 202 is fixed to a rotary driving unit of a rotation sensor 205 that is composed of a rotary encoder. In this case, the rotation sensor 205 which has a hollow center portion is attached to the printed circuit board, and the switch unit 206 is attached to a portion of the printed circuit board where the hollow portion is positioned.

If the inner handle 201 is press-manipulated, the operation shaft 203 moves in the pressing direction, and the switch 206 which is positioned below the center portion of the operation piece is pressed. When the switch 206 detects the pressing manipulation, it outputs a pressing manipulation signal to the control unit 101. Also, if the inner handle 201 is tilt-manipulated, the operation shaft is tilted, and the switch 206 that is positioned below the end portion of the operation piece 204 is pressed according to the slope of the operation shaft. The pressed switch 206 outputs a tilt manipulation signal that indicates the tilt manipulation in the corresponding direction to the control unit 101. At this time, for example, if one portion of the switch 206 that is positioned below the operation piece 204 is pressed, the control unit 101 determines that a tilt manipulation is made in up, down, left, and right directions, while if two portions of the switch 206 are pressed, the control unit determines that a tilt manipulation is made in a tilt direction between the two portions of the switch 206 by the tile manipulation signals from the two corresponding portions of the switch 206. Also, if the outer handle 202 is rotation-manipulated, the rotary driving unit of the rotation sensor 205 is rotated, and the rotation sensor 205 outputs a signal according to the rotating manipulation direction and the rotating manipulation amount.

Also, one handle structure can be realized instead of two inner and outer handle structure as described above. FIG. 2D is a schematic section view of the remote manipulation unit 116 having one-handle structure. The handle 211 is attached to the operation shaft 213 of the switch unit that detects the pressing manipulation and the tilt manipulation. In the switch unit, the operation shaft 213 is installed, which extends in the pressing manipulation direction and is fixed to a switch chassis (fixed to a printed circuit board) 219 so that it can somewhat elastically move with an elastic material such as rubber, and at the other end of the operation shaft 213, an operation piece 214 that spreads out crosswise is installed. Also, on respective end portions and the center portion of the operation piece 214, pressing protrusions are formed to press a switch 216 which is installed on the printed circuit board that is positioned below the operation piece. A portion 217 that is inserted into the handle 211 of the operation shaft 213 has a circular section, and balls 212 are interposed in grooves between the operation shaft 213 and the handle 211 (the balls 212 are rotatably fixed in holes of the operation shaft 213 or the handle 211). In this structure, the operation shaft 213 is not rotated to follow the rotation of the handle 211. Also, a portion 218 that is inserted into a switch chassis 219 of the operation shaft 213 has a tetragonal section, and an insertion hole of the operation shaft 213 in the switch chassis 219 has the same tetragonal section (is large enough to accommodate the operation shaft inserted therein). Accordingly, although the operation shaft 213 is not rotated against the rotation of the handle 211, the operation shaft 213 moves to follow the pressing manipulation and the tilt manipulation of the handle 211.

Also, the handle 211 is fixed to the rotary driving unit of the rotation sensor 215, which is composed of a rotary encoder and the like and is fixed to the switch chassis 219, to be movable in a pressing direction (in the drawing, upper limit direction). In this case, the rotation sensor 215 which has a hollow center portion is attached onto the switch chassis 219, and its signal line is connected to a circuit pattern of the printed circuit board. At this time engagement portions of the handle 211 and the rotary driving unit of the rotation sensor 215 are all in the shape of a tetragonal section, and the rotary driving unit of the rotation sensor 215 is rotated to follow the rotating manipulation of the handle 211. Also, engagement portions of the handle 211 and the rotation sensor 215 have no engagement structure in a pressing manipulation movement range of the handle in the pressing direction (in the drawing, upper limit direction), and the handle 211 is movable in the pressing direction. At this time, although the illustration is omitted, an engagement structure (for example, combination of prominence and depression structures) that restricts the pressing manipulation movement range of the handle 211 exists, and prevents the disengagement of the handle 211 from the rotation sensor.

In this handle structure, if the handle 211 is press-manipulated, the operation shaft 213 moves in the pressing direction, and the switch 216 which is positioned below the center portion of the operation piece is pressed. When the switch 216 detects the pressing manipulation, it outputs a pressing manipulation signal to the control unit 101. Also, if the handle 211 is tilt-manipulated, the operation shaft is tilted, and the switch 216 that is positioned below the end portion of the operation piece 214 is pressed according to the slope of the operation shaft. The pressed switch 216 outputs a tilt manipulation signal that indicates the tilt manipulation in the corresponding direction to the control unit 101. At this time, for example, if one portion of the switch 216 that is positioned below the operation piece 214 is pressed, the control unit 111 determines that a tilt manipulation is made in up, down, left, and right directions, while if two portions of the switch 216 are pressed, the control unit determines that a tilt manipulation is made in a tilt direction between the two portions of the switch 216 by the tile manipulation signals from the two corresponding portions of the switch 216. Also, if the handle 212 is rotation-manipulated, the rotary driving unit of the rotation sensor 215 is rotated, and the rotation sensor 215 outputs a signal according to the rotating manipulation direction and the rotating manipulation amount.

Next, the operation of the vehicle-mounted information process according to an embodiment of the present invention will be described.

The control unit 101 executes the processing of the vehicle-mounted information processing apparatus according to a user's manipulation by executing a program stored in the memory 115 in accordance with the manipulation of the remote manipulation unit 116 or the manipulation unit 114, and provides various kinds of content to a user.

Also, the control unit 101 distributes images and audios from various kinds of content (the broadcast receiving unit 102, the disc reproduction unit 103, the HD reproduction unit 104, and the navigation unit 105) to the image control circuit 109 and the audio control circuit 110, respectively, through the distribution circuit 108 that distributes the designated content to the audio control circuit 110 and the image control circuit 109 based on the instruction from the control circuit 101. The image control circuit 109 controls the luminance, color tone, contrast, and the like of the images, and the image output unit 112 displays the controlled images on the display unit 113. The audio control circuit 110 controls the distribution of the audios to the respective speakers 111, volume, and audios, and the speakers 111 output the controlled audios.

Next, various kinds of operation modes in the AVN integrated appliance as shown in FIG. 1 will be described.

[Broadcast Receiving Mode]

The broadcast receiving mode is a mode for receiving and reproducing broadcasts such as AM/FM/TV broadcasts through the broadcast receiving unit 102. The hierarchys of selection items in the broadcast receiving mode may be a received band (AM/FM/TV), a received frequency (received channel), and a service that is included in the same broadcasting wave in a digital broadcast (for example, in a digital terrestrial TV, three programs may be broadcast with a standard picture quality in the same broadcast).

If a reproduction instruction signal of a received broadcast is input from the remote manipulation unit 116 or the manipulation unit 114, the control unit 101 outputs a start signal, a received band (AM/FM/TV) in the just previous broadcast receiving mode, and data of the received frequency to the broadcast receiving unit 102. When these signals are input, the broadcast receiving unit 102 starts the receiving operation, sets the received band and the received frequency based on the input data, and outputs the audio signal and the image signal of the received broadcasting wave to the distribution circuit 108. Also, the control unit 101 outputs a control signal for outputting the input signal from the broadcast receiving unit 102 to the following end to the distribution circuit 108. The distribution circuit 108 receives this control signal, and outputs the audio signal from the broadcast receiving unit 102 to the audio control circuit 110 and the image signal to the image control circuit 109, respectively. Also, the control unit 101 outputs various kinds of control signals to the audio control circuit 110, the image control circuit 109, and the image output unit 112 in accordance with the manipulation situation of the remote manipulation unit 116 and the manipulation unit 114 and the receiving state of the broadcasting wave.

The audio control circuit 110, in accordance with the audio control signal from the control unit 101, performs a control process of the audio quality, volume, and the like, power-amplifies and outputs the audio signal, which is input to the audio control circuit 110, to the speaker 111. The speaker 111 outputs the input audio signal as the audio. Also, the image control circuit 109, according to the image control signal from the control unit 101, controls the luminance, color tone, contrast, and the like of the input image signal, and outputs the controlled image signal to the image output unit 112. On the other hand, the control unit 101 outputs a received information image, such as a manipulation screen for manipulating the broadcast receiving unit, channel number, and the like, and an image signal such as data images of a multi-broadcast to the image output unit 112. The image output unit 112 synthesizes the image signal input from the image control circuit 109 and the image signal input from the control unit 101 in accordance with a synthesis control signal input from the control unit 101, and outputs the synthesized image signal. The display unit 113 displays the image on the display unit 113 based on the image signal input from the image output unit 112.

[Disc Reproduction Mode]

A disc reproduction mode is a mode in which a disc reproduction unit 103 reads and reproduces information from a recording medium disc such as CD/DVD/BD. The hierarchy of selection items in the disc reproduction mode (in the case of a changer that selectively reproduces a plurality of discs) may be, for example, a disc type (CD/DVD/BD), a disc name (album name, movie name, and the like), a track number (title of music piece), and a chapter number (partition of images).

The control unit 101, if a disc reproduction instruction signal is input from the remote manipulation unit 116 or the manipulation unit 114, outputs a start signal and a reproduction interruption data that indicates the reproduction state in the just previous disc reproduction mode to the disc reproduction unit 103. If these signals are input, the disc reproduction unit 103 starts a reading operation of the information recorded on the disc, sets the read start position of the disc based on the reproduction interruption data so as to make the disc read start position or the like correspond to the reproduction state in the just previous disc reproduction mode to perform the operation, decodes the data read from the disc, and outputs the decoded audio signal and image signal to the distribution circuit 108. The control unit 101 outputs a control signal for outputting the input signal from the disc reproduction unit 103 to the following end to the distribution circuit 108. The distribution circuit 108 receives the control signal, and outputs the audio signal from the disc reproduction unit 103 to the audio control circuit 110 and the image signal to the image control circuit 109, respectively. Also, the disc reproduction unit 103 outputs additional data, such as text data of the read chapter name, track name, title name, and the like, to the control unit 101. Also, the control unit 101 outputs various kinds of control signals to the audio control circuit 110, the image control circuit 109, and the image output unit 112 in accordance with the manipulation situation of the remote manipulation unit 116 or the manipulation unit 114 and the reproduction state of the data read from the disc.

The audio control circuit 110, in accordance with the audio control signal from the control unit 101, performs a control process of the audio quality, volume, and the like, power-amplifies and outputs the audio signal to the speaker 111. The speaker 111 outputs the input audio signal as the audio. Also, the image control circuit 109, according to the image control signal from the control unit 101, controls the luminance, color tone, contrast, and the like of the input image signal, and outputs the controlled image signal to the image output unit 112. On the other hand, the control unit 101 outputs a manipulation screen for manipulating the disc reproduction unit, reproduction information such as a chapter number, a track name, and the like, and an image signal such as an image and the like, to the image output unit 112. The image output unit 112 synthesizes the image signal input from the image control circuit 109 and the image signal input from the control unit 101 in accordance with a synthesis control signal input from the control unit 101, and outputs the synthesized image signal. The display unit 113 displays the image based on the image signal input from the image output unit 112.

[HD Reproduction Mode]

An HD reproduction mode is a mode in which an HD reproduction unit 104 reads and reproduces information recorded on HD. The HD reproduction unit 104, since it has a large recording capacity, for example, enables a user to perform a music piece search in diverse hierarchy structures by giving additional information to the music piece. For example, the HD reproduction unit enables a user to collect, make a list of, and select music pieces by artists, enables a user to collect, make a list of, and select music pieces by discs recorded, i.e. by albums, or enables a user to collect, make a list of (so called a type expressed as “My Best” or the like), and select music pieces by music genres, or enables a user to make a list of, and select music pieces collected according to the user's taste. The hierarchy of selection items in the HD reproduction mode, for example, may be a list kind type (artist/album/genre/“My Best”), items or the like in a list (artist name/album name/genre name/“My Best” name), and a music piece title.

The control unit 101, if an HD reproduction instruction signal is input from the remote manipulation unit 116 or the manipulation unit 114, outputs a start signal and a reproduction interruption data that indicates the reproduction state in the just previous HD reproduction mode to the HD reproduction unit 104. If these signals are input, the HD reproduction unit 104 starts a reading operation of the information recorded on the HD, sets the read start position of the HD based on the reproduction interruption data so as to make the HD read start position or the like correspond to the reproduction state in the just previous disc reproduction mode to perform the operation, decodes the data read from the HD, and outputs the read audio signal and image signal to the distribution, circuit 108. The control unit 101 outputs a control signal for outputting the input signal from the HD reproduction unit 104 to the following end to the distribution circuit 108. The distribution circuit 108 receives the control signal, and outputs the audio signal from the HD reproduction unit 104 to the audio control circuit 110 and the image signal to the image control circuit 109, respectively. Also, the distribution circuit 108 outputs additional data, such as text data of the read chapter name, track name, title name, and the like, to the control unit 101. Also, the control unit 101 outputs various kinds of control signals to the audio control circuit 110, the image control circuit 109, and the image output unit 112 in accordance with the manipulation situation of the remote manipulation unit 116 or the manipulation unit 114 and the reproduction state of the data read from the disc.

The audio control circuit 110, in accordance with the audio control signal from the control unit 101, performs a control process of the audio quality, volume, and the like, power-amplifies and outputs the audio signal, which is input to the audio control circuit 110, to the speaker 111. The speaker 111 outputs the input audio signal as the audio. Also, the image control circuit 109, according to the image control signal from the control unit 101, controls the luminance, color tone, contrast, and the like of the input image signal, and outputs the controlled image signal to the image output unit 112. On the other hand, the control unit 101 outputs a manipulation screen for manipulating the HD reproduction unit, reproduction information such as a chapter number, a track name, and the like, and an image signal such as an image and the like, to the image output unit 112. The image output unit 112 synthesizes the image signal input from the image control circuit 109 and the image signal input from the control unit 101 in accordance with a synthesis control signal input from the control unit 101, and outputs the synthesized image signal. The display unit 113 displays the image based on the image signal input from the image output unit 112.

[Navigation Mode]

A navigation mode is a mode in which display of a map, vehicle position, and the like, and display of a navigation manipulation screen are performed, and a navigation manipulation can be performed through a touch panel or the like based on the display screen. In this ease, even in a navigation mode, the audio reproduction by the broadcast receiving unit 102, the disc reproduction unit 103 or the HD reproduction unit 140 continues.

The control unit 101, if a navigation manipulation instruction signal is input from the remote manipulation unit 116 or the manipulation unit 114, outputs a start signal and a manipulation instruction signal to the navigation unit 105. If the start signal is input, the navigation unit 105 starts a guide operation, and outputs a start signal to a VICS broadcast receiving unit 102 and a GPS information receiving unit 107. On the other hand, if the start signal is input from the navigation unit 105, the VICS broadcast receiving unit 102 starts a VICS receiving operation, and outputs received traffic information to the navigation unit 105. Also, if the start signal in input from the navigation unit 105, the UPS information receiving unit 107 starts a CPS receiving operation, and outputs current position information received to the navigation unit 105. Also, the navigation unit 105 performs a route search or route change of the destination based on the traffic information input from the VICS broadcast receiving unit 102, the current position information input from the GPS information receiving unit 107, and the manipulation instruction signal input from the control unit 101, and outputs the audio signal and image signal which are necessary for the navigation mode to the distribution circuit 108.

In this case, the navigation unit 105 starts when an engine of the vehicle starts, and thereafter, continuously performs vehicle position calculation, reception of VICS broadcasting information whilst the engine operation. In the same manner, the VICS broadcast receiving unit 102 and the GPS information receiving unit 107 continue their operation regardless of the reproduction mode whilst the engine operation. Accordingly, if there is a manipulation for the navigation device, path guide information such as display of the vehicle position on a map or the like can be immediately provided. The control unit 101 outputs a control signal for outputting the input signal from the navigation unit 105 to the following end to the distribution circuit 108. The distribution circuit 108 receives this control signal, and outputs the audio signal from the navigation unit 105 to the audio control circuit 110 and the image signal to the image control circuit 109, respectively.

Also, the control unit 101 outputs various kinds of control signals to the audio control circuit 110, the image control circuit 109, and the image output unit 112 in accordance with the manipulation situation of the remote manipulation unit 116 and the manipulation unit 114 and the guide state. The audio control circuit 110, in accordance with the audio control signal from the control unit 101, performs a control process of the audio quality, volume, and the like, power-amplifies and outputs the audio signal, which is input to the audio control circuit 110, to the speaker 111. The speaker 111 outputs the input audio signal as the audio. Also, the image control circuit 109, in accordance with the image control signal from the control unit 101, controls the luminance, color tone, contrast, and the like of the input image signal, and outputs the controlled image signal to the image output unit 112. On the other hand, the control unit 101 outputs guide information such as a manipulation screen for manipulating the navigation unit and an image signal such as an image to the image output unit 112. The image output unit 112 synthesizes the image signal input from the image control circuit 109 and the image signal input from the control unit 101 in accordance with a synthesis control signal input from the control unit 101, and outputs the synthesized image signal. The display unit 113 displays the image on the display unit 113 based on the image signal input from the image output unit 112.

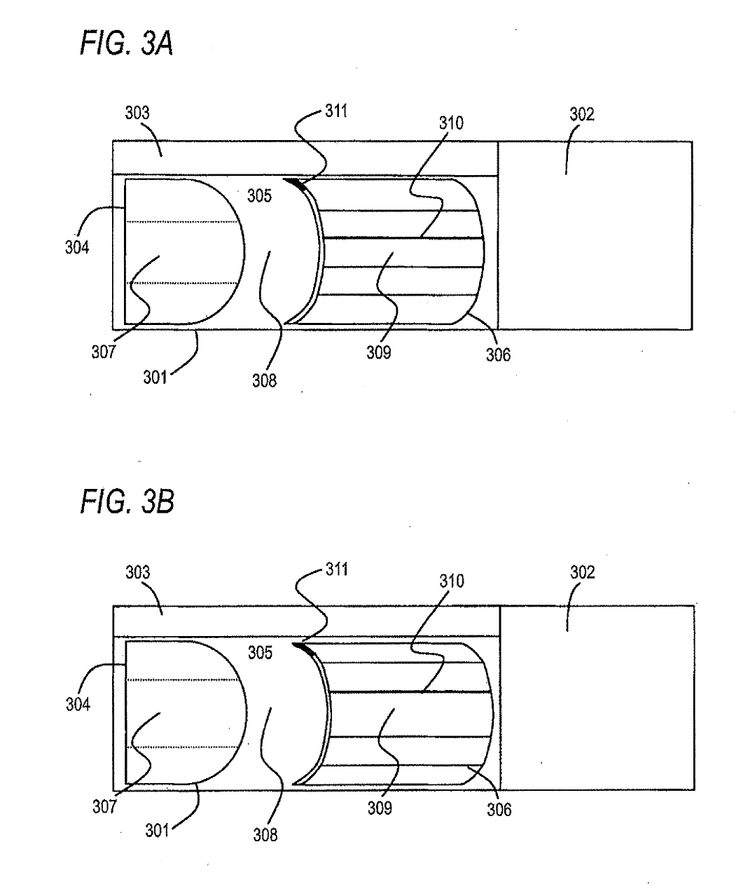

FIGS. 3A to 11 are schematic diagrams of manipulation screens displayed on the display unit 113 under the control of the control unit 101. These manipulation screens are changed based on the user's manipulation through the remote manipulation unit 116 or the manipulation unit 114.

FIG. 3A schematically shows a manipulation screen. The manipulation screen is divided into a manipulation screen area 301, a sub-screen area 302, and an operation state display area 303. In the sub-screen area 302, images before the manipulation screen is displayed, for example, a map image of navigation, an image of a digital terrestrial TV, a DVD reproduced image, a back camera capture image, and the like, are displayed. In the operation state display area 303, the operation states of the AVN integrated appliance, for example, a source name being reproduced, a track number of a music piece, a reproduction mode, a reproduction time, and the like, are displayed.

Also, a selection screen area that performs the display for the manipulation is divided into an upper area 304, an intermediate area 305, and a lower area 306. Various kinds of upper hierarchy items are displayed in the upper area 304, and an upper hierarchy item that is in a selected state is displayed in an upper selection display area (the center of upward/downward direction of the upper area 304) 307. Intermediate hierarchy items are displayed in the intermediate area 305, and an intermediate hierarchy item that is in a selected state is in an intermediate selection display area (the center of upward/downward direction of the intermediate area 305) 308. Lower hierarchy items are displayed in the lower area 306, and a lower hierarchy item that is in a selected state is displayed in a lower selection display area (the center of upward/downward direction of the lower area 306) 309. Also, a boundary line 310 is a boundary line that indicates an end of a list of the lower hierarchy items and a start end portion. By indicating the boundary line 310, the user can confirm one end or both ends of the items. A scroll bar 311 indicates the position of the whole list displayed along the lower area 306. The items displayed in the lower area 306 may be cyclically displayed. Through such a cyclical display, the user can confirm the same item several times by an input manipulation in one direction.

FIG. 3B schematically illustrates a modified example of the manipulation screen area 301 of the selection manipulation. The display area of each item displayed in the upper area 304 and the lower area 306 may become gradually smaller as it is further apart from the item that is in a selected state. By displaying the display area of the item that is in a selected state with the largest size, the user can easily see the item that is currently in a selected state.

[Menu Screen]

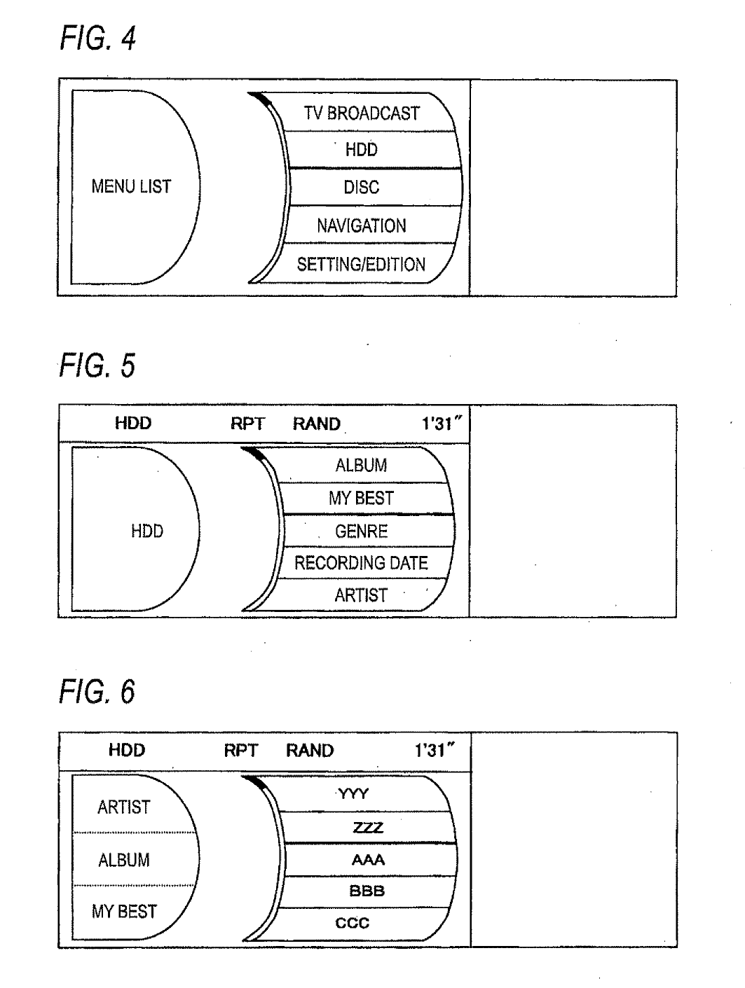

FIG. 4 is a schematic diagram of a menu screen. This menu screen is displayed when a menu key is manipulated. In the upper area 304 of the manipulation screen area 301, a title “menu” of the menu screen is displayed. Also, in the lower area 306, selectable source names (“TV Broadcast”, “Disc”, and the like) are displayed. If the remote manipulation unit 116 is rotation-manipulated, the item that is in a selected state in the lower selection area moves in order. For example, if the remote manipulation unit 116 is backwardly rotated in a display state of FIG. 4, the item that is in a selected state moves from “Disc” to “HDD” and “TV Broadcast”. Also, if the remote manipulation unit is forwardly rotated, the item that is in a selected state moves from “Disc” to “Navigation” and “Setting/Edition”. As described above, if the rotating manipulation is forward rotation, the item that is in a selected state moves downward in order, while if the rotating manipulation is backward rotation, the item that is in a selected state moves upward in order. In this case, the display type of the item that is in a selected state, for example, the text color, background color, font, text size, or the like, may be changed in addition. Although in the menu screen of this embodiment, the sub-screen area 302 is omitted, the display type may be adopted, in which the sub-screen area 302 is removed and the manipulation screen area 301 occupies the whole screen.

In this case, the moving direction of the item that corresponds to the forward rotation may be set so that the user's manipulation rotation direction and the sense of the moving direction of the item coincide with each other according to the display type (the design of the manipulation screen and so on). Also, the rotating manipulation to be described hereinafter may be performed in the same manner.

Also, if the remote manipulation unit 116 is press-manipulated, the manipulation screen is shifted to the manipulation screen of the item that is in a selected state at that time (the item that is in a selected state in the lower selection area). For example, if the item that is in a selected state is “HDD”, the manipulation screen is shifted to an HDD manipulation screen when the remote manipulation unit 116 is press-manipulated.

The manipulation through the remote manipulation unit 116 has been described. In manipulating a touch panel constituting the manipulation unit 114, the item that corresponds to the touched position is considered to be selected, and the corresponding operation is performed. The touch panel manipulation to be described hereinafter will operate in the same manner.

[HDD Manipulation Screen]

FIG. 5 is a schematic diagram of an HDD manipulation screen. The HDD manipulation screen is displayed when the mode is shifted to an HD reproduction mode according to the menu screen or direct key manipulation. In the upper area 304 of the manipulation screen area 301, the title “HDD” of the HDD manipulation screen is displayed. Also, in the lower area 306, selectable search items (“Album”, “Artist”, and the like) are displayed. In the same manner as the menu screen, if the remote manipulation unit 116 is rotation-manipulated, the item that is in a selected state in the lower selection area moves in order. For example, if the remote manipulation unit 116 is backwardly rotated in a display state of FIG. 5, the item that is in a selected state moves from “Genre” to “My Best” and “Album”. Also, if the remote manipulation unit is forwardly rotated, the item that is in a selected state moves from “Genre” to “Recording Date” and “Artist”. As described above, if the rotating manipulation is forward rotation, the item that is in a selected state moves downward in order, while if the rotating manipulation is backward rotation, the item that is in a selected state moves upward in order. In this case, the display type of the item that is in a selected state, for example, the text color, background color, font, text size, or the like, may be changed in addition. Also, if the music piece being reproduced has ended and the next music piece is shifted to reproduction, the music piece information about the new corresponding reproduced music piece is displayed as the item that is in a selected state in the lower selection area according to the shift to the reproduced music piece.

Also, if the remote manipulation unit 116 is press-manipulated in a state where the item that is in a selected state is “Album”, the manipulation screen is shifted to an album search manipulation screen. If the remote manipulation unit 116 is tilt-manipulated in the left direction, the manipulation screen is shifted to the menu screen.

[Album Search Manipulation Screen]

FIG. 6 is a schematic diagram of an album search manipulation screen. The album search manipulation screen is displayed when the manipulation screen is shifted from the HDD manipulation screen. Search items are displayed in the upper area 304 of the manipulation screen area 301, and the item “Album” that is in a selected state is displayed in the upper selection display area 307. Also, selectable album names are displayed in the lower area 306. In the same manner as the menu screen, if the remote manipulation unit 116 is rotation-manipulated, the item that is in a selected state in the lower selection area moves in order. For example, if the remote manipulation unit 116 is backwardly rotated in a display state of FIG. 6, the item that is in a selected state moves from “AAA” to “ZZZ” and “YYY”. Also, if the remote manipulation unit is forwardly rotated, the item that is in a selected state moves from “AAA” to “BBB” and “CCC”. As described above, if the rotating manipulation is forward rotation, the item that is in a selected state moves downward in order, while if the rotating manipulation is backward rotation, the item that is in a selected state moves upward in order. In this case, the display type of the item that is in a selected state, for example, the text color, background color, font, text size, or the like, may be changed in addition.

Also, if the remote manipulation unit 116 is press-manipulated in a state where the item that is in a selected state is “AAA”, the manipulation screen is shifted to a music piece search manipulation screen for selecting a music piece in the album “AAA”. If the remote manipulation unit 116 is tilt-manipulated in the upward/downward direction, the item that is in an upper selected state moves. For example, in the case of the tilt manipulation in the upward direction, the manipulation screen moves from “Album” to “Artist”, while in the case of the tilt manipulation in the downward direction, the manipulation screen moves to “My Best”. Also, if the item that is in a upper selected state moves, the corresponding manipulation screen, for example, the lower area 306 in which “Artist” is in an upper selection state is changed to the screen in which the artist name is displayed. If the remote manipulation unit 116 is tilt-manipulated in the left direction, the manipulation screen is shifted to the screen of the upper hierarchy items, that is, the HDD manipulation screen.

[Music Piece Selection Manipulation Screen]

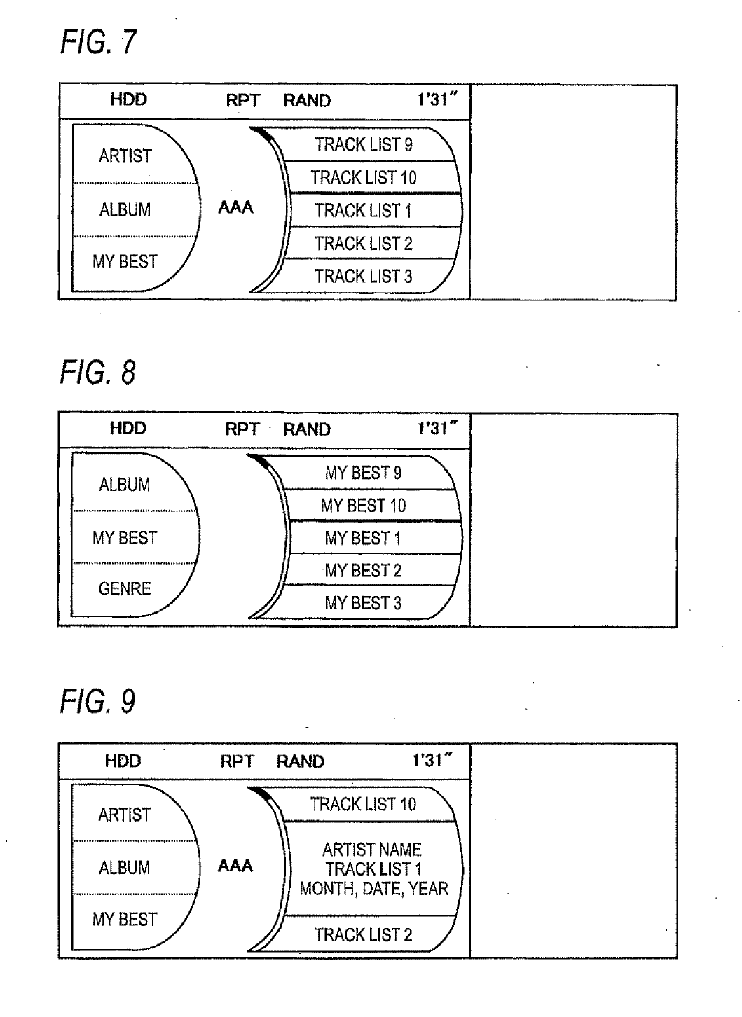

FIG. 7 is a schematic diagram of a music piece selection manipulation screen. Search items are displayed in the upper area 304 of the manipulation screen area 301, and an item that is in a selected state in the just previous manipulation screen, i.e. “Album” in this embodiment, is displayed in the upper selection display area 307. Also, in the intermediate area 305, an item that is in a selected state in the just previous manipulation screen, i.e. album name “AAA” in this embodiment, is displayed in the intermediate selection display area 308. Also, selectable music piece titles are displayed in the lower area 306. In the same manner as the menu screen, if the remote manipulation unit 116 is rotation-manipulated, the item that is in a selected state in the lower selection area moves in order. For example, if the remote manipulation unit 116 is backwardly rotated in a display state of FIG. 7, the item that is in a selected state moves from “Track List 1” to “Track List 10” and “Track List 9”. Also, if the remote manipulation unit is forwardly rotated, the item that is in a selected state moves from “Track List 1” to “Track List 2” and “Track List 3”. As described above, if the rotating manipulation is forward rotation, the item that is in a selected state moves downward in order, while if the rotating manipulation is backward rotation, the item that is in a selected state moves upward in order. In this case, the display type of the item that is in a selected state, for example, the text color, background color, font, text size, or the like, may be changed in addition.

Also, if the item that is in a selected state, for example, “Track List”, continues for a predetermined time, the manipulation screen is shifted to a music piece title display enlargement screen. If the remote manipulation unit 116 is tilt-manipulated in the upward/downward direction, the item that is in an upper selected state moves. For example, in the case of the tilt manipulation in the upward direction, the manipulation screen moves from “Album” to “Artist”, while in the case of the tilt manipulation in the downward direction, the manipulation screen moves to “My Best”. Also, if the item that is in an upper selected state moves, the screen is changed to the corresponding manipulation screen. For example, in the case of the tilt manipulation in the downward direction, the manipulation screen is shifted to a “My Best” search manipulation screen. Also, if the remote manipulation unit 116 is tilt-manipulated in the left direction, the manipulation screen is shifted to the manipulation screen of the upper hierarchy items, that is, the album selection manipulation screen.

In the foregoing description, it is exemplified that “Album” is selected in the upper area. However, the same manipulation contents and display state are obtained even in a state where other items, such as “My Best” and the like, are selected.

[My Best Search Manipulation Screen]

FIG. 8 is a schematic diagram of “My Best” search manipulation screen. Search items are displayed in the upper area 304 of the manipulation screen area 301, and an item that is in a selected state in the just previous manipulation screen, i.e. “My Best” in this embodiment, is displayed in the upper selection display area 307. Also, selectable “My Best” names are displayed in the lower area 306. In the same manner as the menu screen, if the remote manipulation unit 116 is rotation-manipulated, the item that is in a selected state in the lower selection area moves in order. For example, if the remote manipulation unit 116 is backwardly rotated in a display state of FIG. 8, the item that is in a selected state moves from “AAA” to “ZZZ” and “YYY”. Also, if the remote manipulation unit is forwardly rotated, the item that is in a selected state moves from “AAA” to “BBB” and “CCC”. As described above, if the rotating manipulation is forward rotation, the item that is in a selected state moves downward in order, while if the rotating manipulation is backward rotation, the item that is in a selected state moves upward in order. In this case, the display type of the item that is in a selected state, for example, the text color, background color, font, text size, or the like, may be changed in addition.

Also, if the remote manipulation unit 116 is press-manipulated in a state where the item that is in a selected state is “My Best 1”, the item is shifted to the music piece search manipulation screen. If the remote manipulation unit 116 is tilt-manipulated in the upward direction and downward direction, the item that is in an upper selected state is shifted. For example, in the case of the tilt manipulation in the upward direction, the manipulation screen moves from “My Best” to “Album”, while in the case of the tilt manipulation in the downward direction, the manipulation screen moves to “Genre”. Also, if the item that is in an upper selected state is shifted, the manipulation screen is changed to the corresponding manipulation screen. For example, if the remote manipulation unit 116 is tilt-manipulated in the left direction, the manipulation screen is shifted to the genre search manipulation screen. If the remote manipulation unit 116 is tilt-manipulated in the downward direction, the manipulation screen is shifted to the manipulation screen of the upper hierarchy items, that is, the HDD manipulation screen.

[Music Piece Title Display Enlargement Screen]

In this embodiment, when it is detected that the selection manipulation is stopped, a display area of the selected item is enlarged in an arrangement direction in which the items are arranged. FIG. 9 is a schematic diagram of a music piece title display enlargement screen. Search items are displayed in the upper area 304 of the manipulation screen area 301, and an item that is in a selected state, i.e. “Album” in this embodiment, is displayed in the upper selection display area 307. Also, in the intermediate area 305, an item that is in a selected state, i.e. album name “AAA” in this embodiment, is displayed in the intermediate selection display area 308. Also, selectable music piece titles are displayed in the lower area 306 and are arranged in an arrangement direction (upward/downward direction of the screen). In the music piece title display enlargement screen, the display lower selection display area 309 is enlarged in the arrangement direction relative to the display lower selection display area 309 in the music piece selection manipulation screen. In the lower selection area 309, detailed information about the music piece that is in a selected state, for example, “Artist Name”, “Recording Date”, or the like, is displayed. In this case, the display type of the item that is in a selected state, for example, the text color, background color, font, text size, or the like, may be changed in addition.

Also, if the remote manipulation unit 116 is rotation-manipulated or tilt-manipulated, the manipulation screen is shifted to the just previous manipulation screen, and an operation that corresponds to the corresponding manipulation (change of the display type) is performed.

In the foregoing description, it is exemplified that “Album” is selected in the upper area. However, the same manipulation contents and display state are obtained even in a state where other items, such as “My Best” and the like, are selected.

As described above, by enlarging the hierarchy lower selection display area, the visibility of the item that is selected by the user is improved. Also, by reducing the number of items being displayed, it is possible to further enlarge the enlarged area of the lower selection display area. Also, it is possible to secure a necessary area according to the item by setting the lower selection display area in accordance with the amount of information about the detailed information or the number of items. The display/non-display of the detailed information may be selected according to the hierarchy.

[Navigation Manipulation Screen]

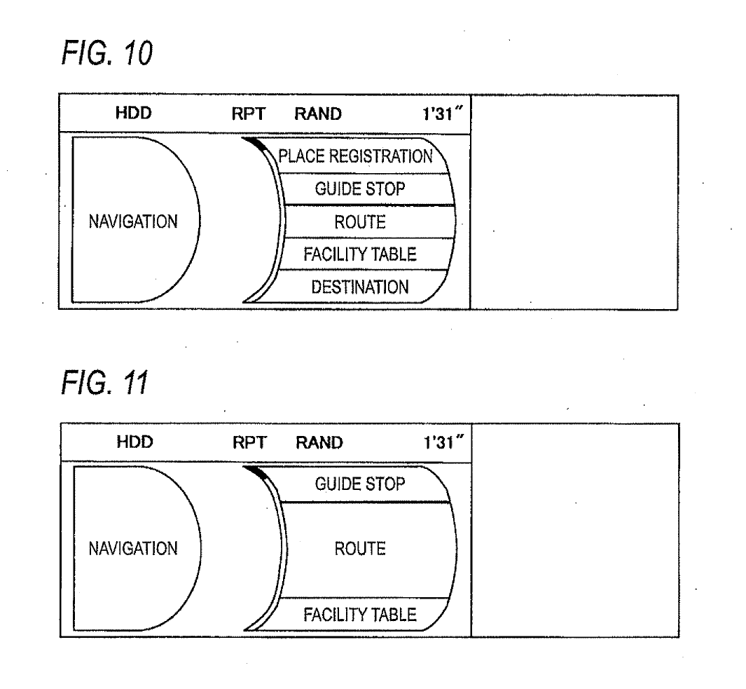

Next, a navigation manipulation screen will be described. FIG. 10 is a schematic diagram of a navigation manipulation screen. A title “Navigation” of the navigation manipulation screen is displayed in the upper area 304 of the manipulation screen area 301. Also, selectable function items (“Place Registration”, “Destination”, and the like) are displayed in the lower area 306. In the same manner as the menu screen, if the remote manipulation unit 116 is rotation-manipulated, the item that is in a selected state in the lower selection area moves in order. For example, if the remote manipulation unit 116 is backwardly rotated in a display state of FIG. 10, the item that is in a selected state moves from “Route” to “Guide Stop” and “Place Registration”. Also, if the remote manipulation unit is forwardly rotated, the item that is in a selected state moves from “Route” to “Facility Table” and “Destination”. As described above, if the rotating manipulation is forward rotation, the item that is in a selected state moves downward in order, while if the rotating manipulation is backward rotation, the item that is in a selected state moves upward in order. In this case, the display type of the item that is in a selected state, for example, the text color, background color, font, text size, or the like, may be changed in addition.

Also, if the item that is in a selected state, for example, “Route”, continues over a predetermined time, the manipulation screen is shifted to the function display enlargement screen. If the remote manipulation unit 116 is tilt-manipulated in the left direction, the manipulation screen is shifted to the manipulation screen of the items of the upper hierarchy, i.e. the menu screen.

[Function Display Enlargement Screen]

FIG. 11 is a schematic diagram of an example of a function display enlargement screen in the navigation manipulation screen. Title is displayed in the upper area 304 of the manipulation screen area 301, and “Navigation” that is in a selected state is displayed in the upper selection display area 307. Selectable function items are displayed in the lower area 306. The lower selection display area is enlarged in the arrangement direction of the selectable function items (upward/downward direction of the screen) relative to the lower selection display area in a normal manipulation screen, and the text with a large size is also displayed. In this case, the display type of the item that is in a selected state, for example, the text color, background color, font, text size, or the like, may be changed in addition.

Also, if the remote manipulation unit 116 is rotation-manipulated or tilt-manipulated, the manipulation screen is shifted to the just previous manipulation screen, and an operation that corresponds to the corresponding manipulation (change of the display type) is performed. By enlarging the hierarchy lower selection display area, the visibility of the item that is selected by the user is improved. Also, by reducing the number of items being displayed, it is possible to further enlarge the enlarged area of the lower selection display area. Also, it is possible to secure a necessary area according to the item by setting the lower selection display area in accordance with the amount of information about the detailed information or the number of items.

As described above, parts of the HDD manipulation screen and the navigation manipulation screen have been described. However, in the same manner as in other manipulation screens, display of the upper area 304, the intermediate area 305, and the lower area 306 and item selection are performed according to the corresponding operation situation or manipulation situation.

A display control of a screen that is displayed on the display unit 113 will be described. The form screens of the respective manipulation screens (background image portion except for text) as shown in FIGS. 3A and 3B are stored in the memory 115. The control unit 101 reads the corresponding form screen from the memory 115, and stores the read form screen in a memory for display processing according to the operation mode and operation state. Also, the control unit 101, in accordance with the operation mode, operation state, and manipulation of the remote manipulation unit 116 or the manipulation unit 114, selects data to be displayed among various kinds of data obtained from the broadcast receiving unit 102, the disc reproduction unit 103, and the like, for example, a source name, album name, music piece name, broadcasting station name (frequency), and the like, calculates a position where the data is to be displayed, and stores the calculated position in the memory for display processing. Also, the control unit generates display image data by performing an image process which lithographs the data to be displayed that is stored in the memory for display processing in the position where the data is to be displayed on the form screen stored in the memory for display processing, and outputs the generated display image data to the image output unit 112.

Accordingly, the image output unit 112 outputs a driving signal for lithographing the manipulation image from the control unit 101 to the display unit 113 to form a desired manipulation screen. At this time, by repeating the image processing, for example, the display of a moving image, in which the display item of the lower area 306 moves, is realized.

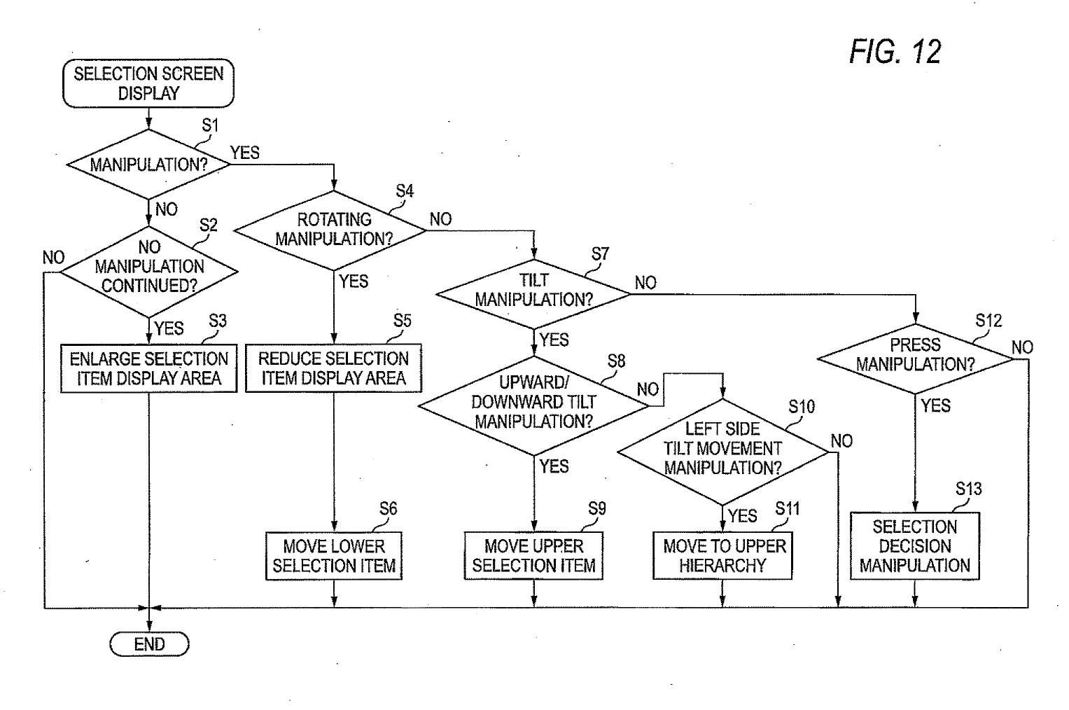

Based on the user's manipulation, an enlargement display process for enlarging the lower selection display area will be described using a flowchart of FIG. 12. This process is repeatedly performed when the selection screen is displayed by the control unit 101.

In step S1, it is determined whether or not the manipulation by the remote manipulation unit 116 exists. If there is no manipulation, the processing proceeds to step S2. If there is a manipulation, the processing proceeds to step S4. In step 82, it is determined whether no manipulation by the remote manipulation unit 116 continues over a predetermined time. The elapsed time for which there is no manipulation after the just previous manipulation of the remote manipulation unit 116 was performed is measured, and if the elapsed time is equal to or longer than a predetermined time (for example, 0.5 second), it is determined that no manipulation continues over the predetermined time, and the processing proceeds to step 83. Also, if the elapsed time is shorter than the predetermined time, it is determined that no manipulation continues for time shorter than the predetermined time, and thus the processing has ended. In step S3, a screen obtained by enlarging the lower selection display area is displayed on the display unit 113, and then the processing has ended. For example, with respect to the music piece selection manipulation screen, the music piece title display portion that is the lower selection display area is enlarged to be displayed. At this time, if the enlarged screen is displayed, the display of the corresponding enlargement display screen continues. In step S4, it is determined whether or not the rotating manipulation of the remote manipulation unit 116 exists. In the case of the rotating manipulation, the proceeding moves to step 85. In the case where the rotating manipulation does not exist, the processing moves to step S6. In step S5, the display area of the lower selection display item is made to have a typical size, i.e. the enlarged display is released, and the processing moves to step S6. At this time, if the display area is in a typical display state (a state where the lower selection display area is not enlarged to be displayed), the display state is maintained. In step S6, the lower selection display item moves to suit the rotating manipulation direction of the remote manipulation unit 116, and then the processing has ended. In step S7, it is determined whether or not the tilt manipulation of the remote manipulation unit 116 exists. In the case of the tilt manipulation, the proceeding moves to step S8. In the case where the tilt manipulation does not exist, the processing moves to step S12. In step S8, it is determined whether or not the tilt manipulation of the remote manipulation unit 116 in the upward/downward direction exists. In the case of the tilt manipulation in the upward/downward direction, the proceeding moves to step S9. In the case where the tilt manipulation in the upward/downward direction does not exist, the processing moves to step S10. In step S9, the upper selection display item moves to suit the upward/downward direction of the tilt manipulation of the remote manipulation unit 116. Also, the shift of the selected screen (display contents of the lower hierarchy) according to the selected upper selection display item is performed. In step S10, it is determined whether or not the tilt manipulation of the remote manipulation unit 116 is the left direction tilt manipulation. In the case of the tilt manipulation in the left direction, the processing moves to step S11. In the case where the tilt manipulation is not the tilt manipulation in the left direction, the processing has ended. In step S11, the hierarchy that was displayed on its upper hierarchy moves to the lower area 306, and then the processing has ended. That is, the object of selection manipulation of the rotating manipulation becomes the upper hierarchy. Also, the shifting of the screen according to the movement of the hierarchy (change of the display contents of the upper/lower area 306) is performed. By this processing, the hierarchy movement to the upper hierarchy is performed. In step S12, it is determined whether or not the manipulation of the remote manipulation unit 116 is the pressing manipulation. In the case of the pressing manipulation, the processing moves to step S13. In the case where the manipulation is not the pressing manipulation, the processing has ended. In step S13, the decision processing of the item of the lower selection display area (it is determined that the item of the lower selection display area is selected, and the selected item is used to process the change of the reproduced music piece and so on) is performed, and then the processing has ended. If there is no manipulation over the predetermined time through the above-described processing, the lower selection display area is enlarged, while if there is the manipulation, such as the rotating manipulation, the tilt manipulation, or the like, the processing that suits the corresponding manipulation can be performed.

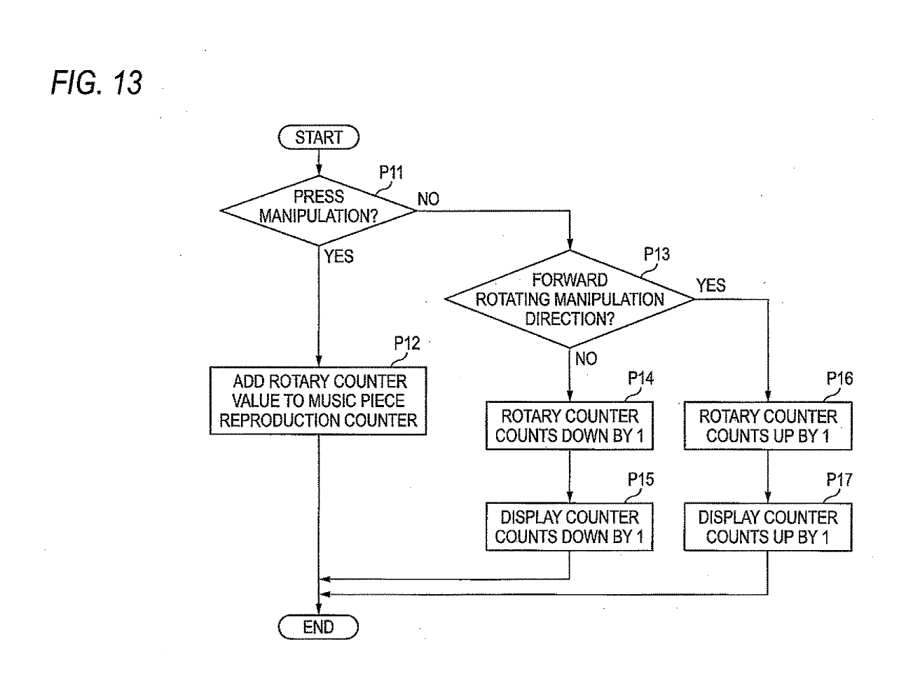

In selecting the reproduced music piece, the reproduction process of the selected music will be described using the flowchart of FIG. 13. FIG. 13 shows the pressing manipulation music reproduction process that reproduces the music piece that is in a selected state when the pressing manipulation (decision manipulation) is performed in the music piece selection manipulation screen. This pressing manipulation music reproduction process is executed by the control unit 101 when the remote manipulation unit 116 is selection-manipulated by the rotating manipulation or the pressing manipulation in the selection screen.

In step P11, it is determined whether or not the selection manipulation is the pressing manipulation. In the case of the pressing manipulation, the processing moves to step P12. Also, if the selection manipulation is not the pressing manipulation, the processing moves to step P13. In step P12, in changing the reproduced music piece, the value of the rotary counter is overwritten on the music piece reproduction counter, and then the processing has ended. The rotary counter is a counter that counts up and down according to the direction of the rotating manipulation, and the corresponding counter value becomes the value that indicates the music piece that is in a selected state. Also, the music reproduction counter is a counter that stores what music piece the music piece being reproduced in the selectable list is, and the music piece recorded in the list which corresponds to the value of the music piece reproduction counter is reproduced (an instruction signal for reproducing the corresponding music piece is output to the HD reproduction unit 104). Through this process, the music being reproduced is shifted to the music that is in a selected state. In step P13, the manipulation direction of the rotating manipulation is determined. In the case of the backward rotation, the processing moves to step P14. Also, in the case of the forward rotation, the processing moves to step P16.

In step P14, the rotary counter value is subtracted by 1, and the processing moves to step P15. In step P15, the display counter value is subtracted by 1, and the processing has ended. The display counter is a counter for designating the music piece that is displayed in the selection display area of the selection screen, and the music piece title that corresponds to the display counter value is displayed in the selection display area. Also, the display counter value is also the value that is used to display the corresponding music piece in the list among the whole music pieces to be selected. In step P16, the rotary counter value is added by 1, and the processing moves to step P17. In step P17, the display counter value is added by 1, and the processing has ended. At this time, in the case of the subtraction from the lower limit value, the rotary counter and the display counter perform recording to overwrite the upper limit value, while in the case of the addition from the upper limit value, the rotary counter and the display counter performs recording to overwrite the lower limit value. That is, if the rotation is made over the front end of the list of the selected music piece, the music of the rear end is reproduced, while if the rotation is made over the rear end of the list, the music of the front end is reproduced. Through the above-described process, the display is updated according to the manipulation direction of the rotating manipulation. Also, by storing the distance from the music being reproduced, the music that is in a selected state is reproduced.

In this case, although the flowchart is omitted, if the reproduced music piece moves regardless of the manipulation, such as if the reproduction is shifted to the reproduction of the next music piece after the end of the music piece being reproduced (the value of the music piece reproduction counter is changed) and so on, the process of “recording the value of the music piece reproduction counter in the display counter” in consideration of the movement to the corresponding reproduced music piece as a trigger is performed to make the music piece information display correspond to the music piece whilst reproduction. By this interruption process, the music piece information about the new corresponding reproduced music piece is displayed as the item that is in a selected state in the lower selection area according to the movement to the reproduced music piece.

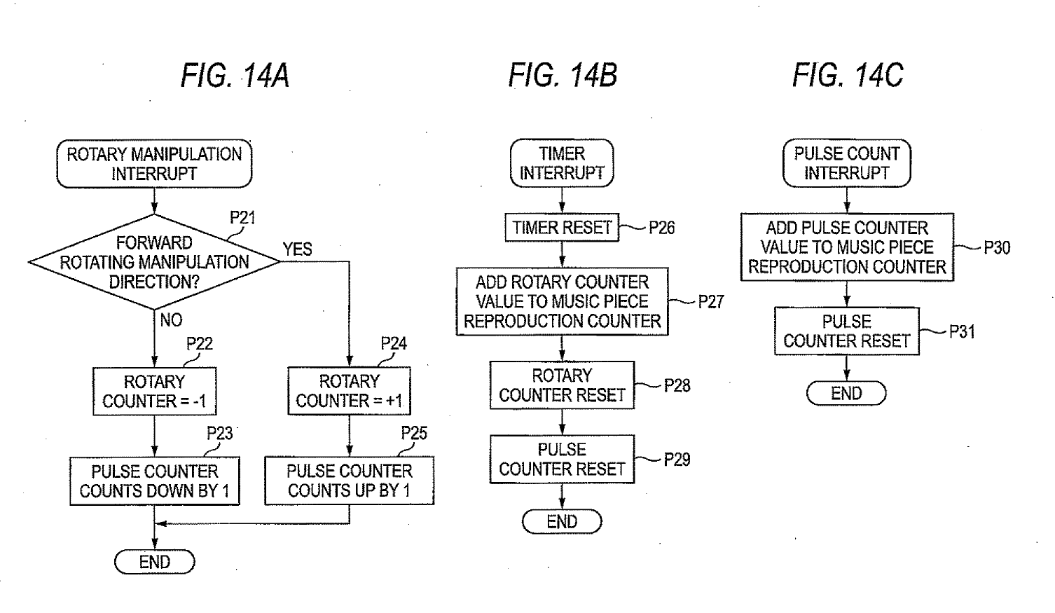

FIGS. 14A, 14B, and 14C are flowcharts illustrating a music piece selection manipulation process which reproduces music that is in a selected state without decision manipulation in the music piece selection manipulation screen and realizing reproduction of the music through skipping over the music pieces if the rotating manipulation continues at high speed. This selection reproduction process is executed by the control unit 101 in accordance with a predetermined interrupting condition in a state where the music piece selection manipulation screen is displayed. In this process, the reproduced music piece and the music piece that is in a selected state coincide with each other, and thus the music piece reproduction counter and the display counter are in a combined use state.

The rotating manipulation interrupting process of FIG. 14A starts when the rotating manipulation is made in a selection manipulation screen display state. In step P21, the rotation direction of the rotating manipulation is determined. If the rotation direction is backward rotation, the processing moves to step P22. Also, if the rotation direction is forward rotation, the processing moves to step P24. In step P22, the rotary counter value is subtracted by 1, and the process moves to step P23. In step P23, the pulse counter value is subtracted by 1, and the rotating manipulation interrupting process has ended. The pulse counter is a counter that is used to determine the high-speed manipulation, i.e. the number of music pieces to be skipped, by counting the number of high-speed rotating manipulations. In step P24, the rotary counter value is set to +1, and the processing moves to step P25. In step P25, the pulse counter value is added by 1, and the rotating manipulation interrupting process has ended.

The timer interrupting process of FIG. 14B is performed at predetermined time intervals in displaying the selection manipulation screen. In this case, the predetermined time corresponds to a value that is set to generate the interruption at the time of the threshold value that is determined as the high-speed manipulation. In step P26, a timer for measuring the predetermined time is reset, and the processing moves to step P27. Based on this timing, the next timer interrupting process is performed after the predetermined time. In step P27, the value that is obtained by adding the rotary counter value to the music piece reproduction counter is overwritten on the music piece reproduction counter, and the processing moves to step P28. That is, if the rotating manipulation with a speed that is not a high speed is performed, the reproduced music piece is shifted to the next music piece or the previous music piece. In step P28, the rotary counter is reset, and the processing moves to step P29. In step P29, the pulse counter is reset, and the timer interrupting process has ended. That is, if the pulse counter value does not reach the counter value that indicates the high-speed manipulation within the predetermined time, the pulse counter is reset, and the movement of the reproduced music piece based on the high-speed manipulation is not performed.

The pulse counter interrupting process of FIG. 14C is a process that reproduces the reproduced music piece by skipping the predetermined number of music pieces in the case where a high-speed rotating manipulation is performed, and starts when the pulse counter value becomes a predetermined number. In step P30, the value that is obtained by adding the pulse counter value to the music piece reproduction counter value is overwritten on the music piece reproduction counter, and the processing moves to step P31. In step P31, the pulse counter is reset, and the pulse counter interrupting process has ended.

[“Return” Manipulation]

In the case of a hierarchy structure in manipulation, particularly, in the case of a deep hierarchy structure, it is frequent that a user desires to return the operation state to the state before the manipulation. In this embodiment, the operation state returns to that before the manipulation by a simple manipulation. That is, by manipulating a “Return” button, the operation state returns to the operation state before the manipulation.

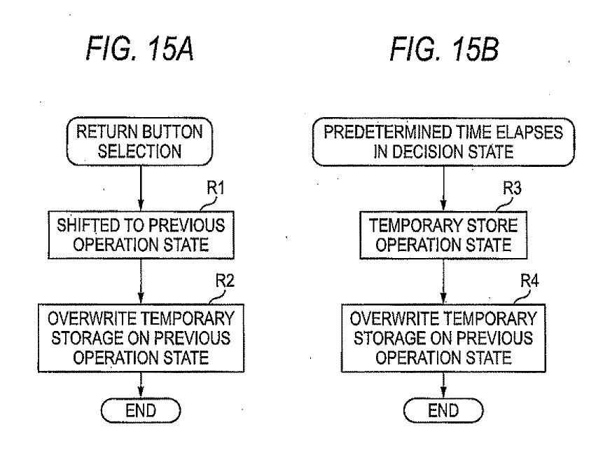

Specifically, when the “Return” button is manipulated, the operation state returns to the latest operation state that continued over the predetermined time before the manipulation. This operation process will be described using the flowchart illustrated in FIGS. 15A and 15B. FIG. 15A illustrates the process when the “Return” button is manipulated, and FIG. 15B illustrates the operation state recording process. The “Return” button manipulation process is performed by the control unit 101 when the “Return” button is manipulated, and the operation state recording process is performed by the control unit 101 when the operation state continues over the predetermined time (when the operation decision state continues over the predetermined time).

If the operation decision state continues over the predetermined time, the operation state recording process starts, and the processing moves to step R1. In step R1, the operation state at that time point is temporarily stored in the memory, and the processing moves to step R2. In step R2, the operation state temporarily stored at the last time is overwritten on the previous operation state recording portion of the memory as the destination of the “Return” manipulation, and then the processing has ended. Through the above-described process, the latest operation state that continued over the predetermined time before the manipulation can be constantly recorded in the previous operation state recoding portion.

Also, if the “Return” manipulation is performed, the “Return” button manipulation process starts, and the processing moves to step R3. In step R3, the operation state recorded in the previous operation state recording portion is read, the operation state of the apparatus is made to be the read operation state, and then the processing moves to step R4. In step R4, the operation state temporarily stored at the last time is overwritten on the previous operation state recording portion of the memory as the destination of the “Return” manipulation, and then the processing has ended. Through the above-described process, the operation state returns to the latest operation state that continued over the predetermined time before the manipulation of the “Return” button, and the latest operation state that continued over the predetermined time before the “Return” manipulation can be recorded in the previous operation state recoding portion.

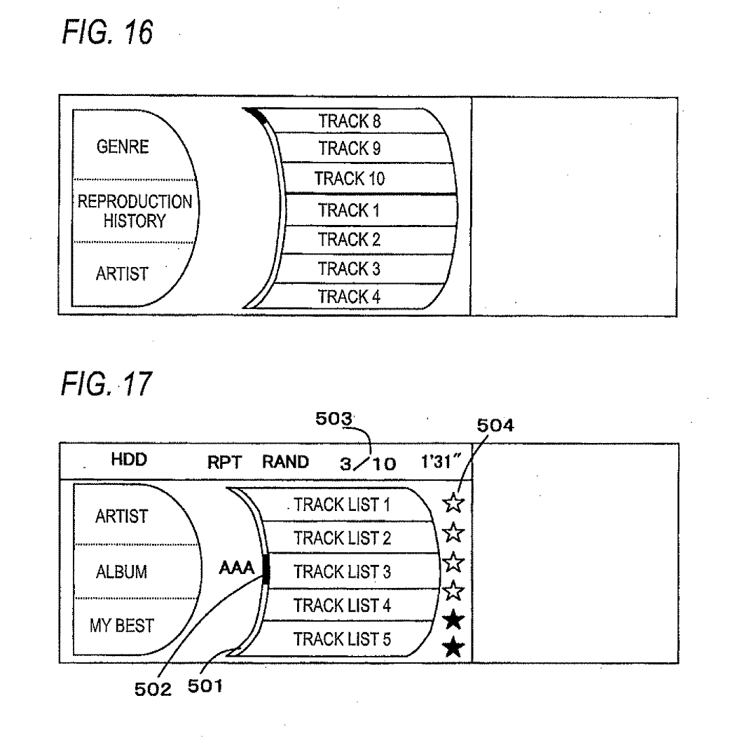

FIG. 16 is a schematic diagram of a historic order music piece selection manipulation screen. Search items are displayed in the upper area 304 of the manipulation screen area 301, and an item that is in a selected state in the just previous manipulation screen, i.e. “Reproduction History” in this embodiment, is displayed in the upper selection display area 307. In this embodiment, the intermediate area 305 is a non-display area. Also, a predetermined number of music piece titles, for example, 7 music piece titles, which were reproduced in the past, are displayed in the order of their reproduction time (as the upper portion of the drawing is nearer, recently reproduced music pieces are displayed) in the lower area 306. In this case, although the number of music pieces simultaneously displayed on the screen is 7 based on the relationship of the size of the screen, for example, about 50 music pieces are provided as display candidates, and the displayed music piece titles are changed by the manipulation to be described hereinafter.

In the same manner as the music piece title menu screen, if the remote manipulation unit 116 is rotation-manipulated, the item that is in a selected state in the lower selection area moves in order. For example, if the remote manipulation unit 116 is backwardly rotated in a display state of FIG. 16, the item that is in a selected state moves from “Track 1” to “Track 10” and “Track 9”. Also, if the remote manipulation unit is forwardly rotated, the item that is in a selected state moves from “Track 1” to “Track 2” and “Track 3”. As described above, if the rotating manipulation is forward rotation, the item that is in a selected state moves downward in order (the recently reproduced music piece side), while if the rotating manipulation is backward rotation, the item that is in a selected state moves upward in order (old reproduced music piece side). In this case, the display type of the item that is in a selected state, for example, the text color, background color, font, text size, or the like, may be changed in addition.

Also, if the item (music piece title) that is in a selected state, for example, “AAA”, continues over the predetermined time, the manipulation screen is shifted to a music piece title display enlargement screen. If the remote manipulation unit 116 is tilt-manipulated in the upward/downward direction, the item that is in an upper selected state moves, and the manipulation screen is changed to the manipulation screen according to the movement.

Also, if a previous music piece reproduction/next music piece reproduction manipulation button such as a touch panel or the like is manipulated on the historic order music piece selection manipulation screen, the music piece, based on the currently reproduced music piece, is shifted to the previous music piece or the next music piece in historic order, and the corresponding music piece is reproduced. At this time, even without the historic order music piece selection manipulation screen, the above-described historic order music piece selection may be performed during the HD reproduction or disc reproduction.

The above-described operation can be realized by storing the reproduced music piece history in the memory and searching for and reproducing the corresponding music piece with reference to the stored reproduced music piece history in the case where the previous music piece reproduction/next music piece reproduction manipulation was performed. Also, by determining the reproduced music pieces that remain as a history as those which were reproduced for a predetermined time (for example, 1 minute) or more, the reproduced music pieces which were not intended by the user can be excluded from the history.

[Position Relationship Display of Selected Items]

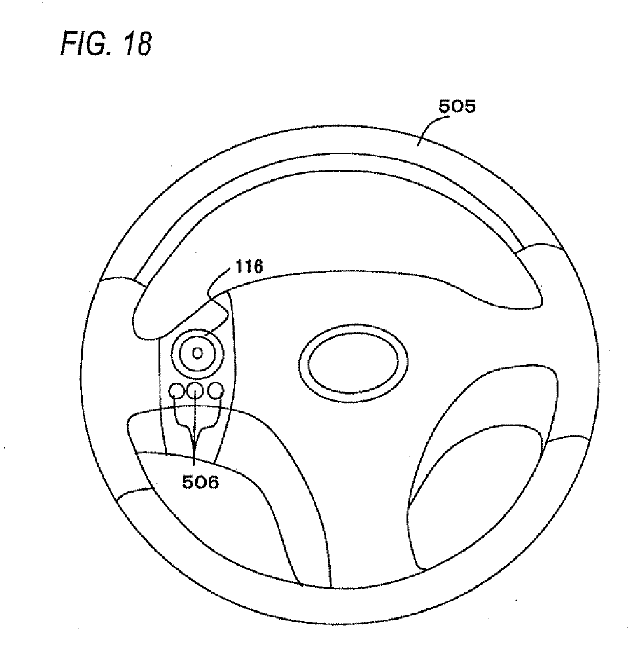

A user sometimes desires to know the position relationships of all items of the list that are in a selected state. In this embodiment, a display that indicates the position relationships in the whole list of the selected items is performed. Specifically, the display takes the shape illustrated in FIG. 17 as follow.

<Bar Display>

A band portion 501 is displayed along the left end portion in an item arrangement direction in the lower area 306. Then, positions according to the order of the respective items are set so that the upper end of the band portion becomes the position of the first item and the lower end thereof becomes the position of the last item, and a position mark 502 is displayed in the position corresponding to the order of the selected item in the band portion 501. At this time, the band portion is divided by the total number of items, and the positions of the respective items are determined by allocating divided positions to the respective items in their order. Such display data are stored in the memory. Such display can be realized by reading the position that corresponds to the selected item from the memory and displaying the position mark 502 in the position.

<Numerical Value Display>

The whole number of items and the order number of the selected item are displayed (503). This can be realized by storing the whole number of items and the order of the respective items in the memory and reading and displaying the order of the selected item and the whole number of items from the memory. Such a display is not limited to the numerical number display, and it is possible to perform display using diagrams 504, for example, using display types such as change of the number of diagrams, change of the size of the diagrams and change of the coloring rate of different colors for a plurality of diagrams, and the like.

Although embodiments of the present invention have been described, the present invention is not limited to those embodiments, and diverse modifications thereof are possible. Hereinafter, such modifications will be described. All types including the types described in the above-described embodiments and types to be described hereinafter can be appropriately combined.

For example, in the above-described embodiments, it is exemplified that an instrument panel remote manipulator 116 is installed. However, the remote manipulation unit 116 may be arranged in a certain device that the user can easily manipulate. For example, as illustrated in FIG. 18, the remote manipulation unit may be installed on a steering wheel 505. In the embodiment illustrated in this drawing, both the remote manipulation unit 116, which can perform all of the rotating manipulation, pressing manipulation, and tilt manipulation, and switch buttons 506, such as a menu key for switching various kinds of modes, a direct key, and the like, are installed on the left side of the steering wheel 505. In this case, the remote manipulation unit 116 may be arranged on the left side of the steering wheel 505, and the switch buttons 506 may be arranged on the right side of the steering wheel 505.

Also, in the above-described embodiment, it is exemplified that the various kinds of appliances are realized by software though the operation process of the CPU 1 according to the program. However, parts of the functions may be realized by electric hardware circuits.

Next, the screen is divided into a main area 507 and a sub area 508, and preferential display types of the respective divided areas will be described.

[Image Preferential Display]

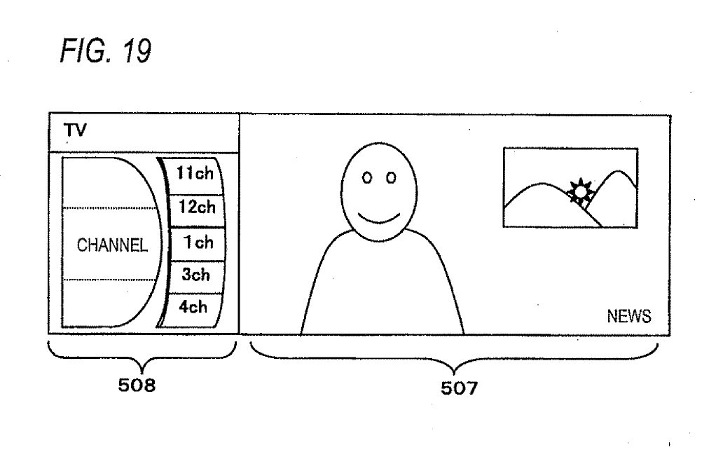

Since an image of a TV broadcast or movie recorded on DVD is for amusement, a high-definition image quality is necessary. Accordingly, in this embodiment, with respect to a specified image of a TV broadcast or the like illustrated in FIG. 19, a display area suitable to the corresponding image is set, the image is expanded or compressed to suit the display area, and the processed image is displayed on the corresponding area. Also, a manipulation screen is displayed on the remaining area. In this case, the display area suitable to the corresponding image may be an area having a size for the maximum image in a state where the original aspect ratio is maintained, or an area having a size in which the number of pixels suits the maintained picture quality (an area having a size which is integer times or 1/integer times the number of dots of the original image, in which no distortion due to the image expansion and compression process occurs).

Also, during the manipulation, in order to heighten the manipulation visibility, the manipulation screen is enlarged until a predetermined time elapses after the completion of the manipulation the start of which is detected, and an image screen such as a TV broadcast or the like is reduced. In the manipulation state, the quality of the image is not so much necessary, and thus manipulability can be improved as suppressing the bad influence on the image quality deterioration.

At this time, such a display can be realized by storing the setting state of the screen area according to the operation state (such as reproduction source selection state and so on) and the manipulation state of the apparatus and setting the screen area by reading the setting state of the screen area that is stored according to the operation state of the apparatus, and performing expansion, compression, and generation of the display image according to the setting state of the screen area.

[Area Preferential Display]

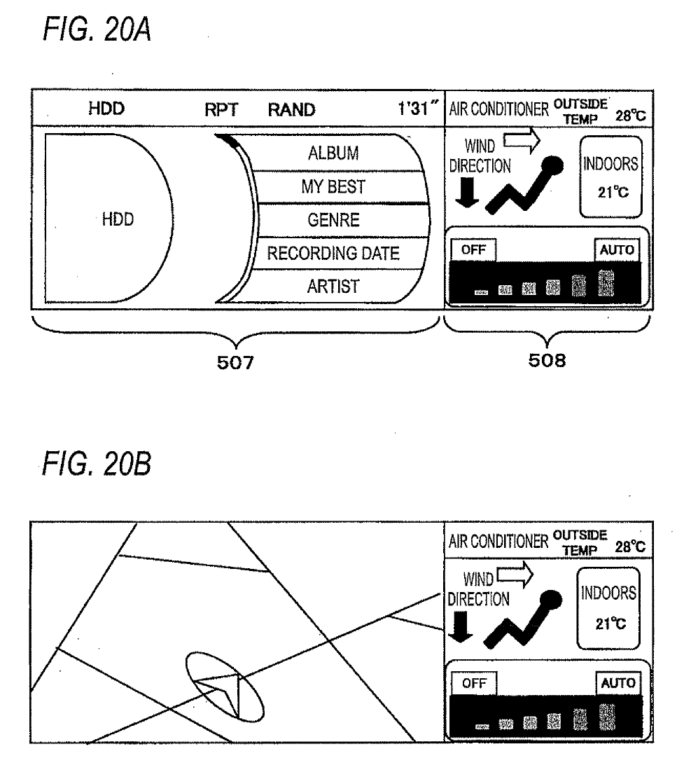

Further, other display types will be described. The screen area is divided into a main area 507 and a sub area 508 (which may be three or more areas). Also, the display priorities of the images are set according to the operation state of the apparatus or the manipulation state, and then are stored in the memory. Then, an image to be displayed is generated according to the operation state of the apparatus and the manipulation state, and based on the kinds of the generated images, the priorities are given thereto in accordance with the set priorities stored in the memory. The images are displayed on the main area 507 and the sub area 508 in the order of their priority, and the images of which the priority is lower than the number of display areas are not displayed. Through this process, as illustrated in FIGS. 20A and 20B, images having upper priorities according to the operation state or the manipulation state of the apparatus are displayed in the main area 507 and the sub area 508, and thereafter, if the operation state or the manipulation state of the apparatus is changed, the images to be displayed and their priorities are also changed, and thus the images to be displayed in the main area 507 and the sub area 508 are changed.

In this case, such display can be realized by storing the setting state of the screen area according to the operation state (such as reproduction source selection state and so on) and the manipulation state of the apparatus, setting the screen area by reading the setting state of the screen area that is stored according to the operation state of the apparatus, setting the priorities of the respective images based on the kinds of the respective images, determining the display areas of the respective images based on the setting state of the screen area and the priorities, performing expansion, compression, and generation of the display image according to the corresponding display areas, and displaying the processed images in the corresponding areas, respectively.

As described above, the embodiments of the present invention have been described with reference to the music piece reproduction selection manipulation in reproducing the music. However, this is merely a detailed example using the technical features of the present invention, and the technical features of the present invention can be applied to diverse types of manipulations in various kinds of electronic devices such as image appliances, navigation devices, and the like, and particularly to devices having a multifunction of which the selection manipulation is complicated.

[Area Preferential Display]

Further, other display types will be described. The screen area is divided into a main area 507 and a sub area 508 (which may be three or more areas). Also, the display priorities of the images are set according to the operation state or the manipulation state of the apparatus, and then are stored in the memory. Then, an image to be displayed is generated according to the operation state and the manipulation state of the apparatus, and based on the kinds of the generated images, the priorities are given thereto in accordance with the set priorities stored in the memory. The images are displayed on the main area 507 and the sub area 508 in the order of their priority, and the images of which the priority is lower than the number of display areas are not displayed. Through this process, as illustrated in FIGS. 20A and 2013, images having upper priorities according to the operation state or the manipulation state of the apparatus are displayed in the main area 507 and the sub area 508, and thereafter, if the operation state or the manipulation state of the apparatus is changed, the images to be displayed and their priorities are also changed, and thus the images to be displayed in the main area 507 and the sub area 508 are changed.

In this case, such display can be realized by storing the setting state of the screen area according to the operation state (such as reproduction source selection state and so on) of the apparatus and the manipulation state, setting the screen area by reading the setting state of the screen area that is stored according to the operation state of the apparatus, setting the priorities of the respective images based on the kinds of the respective images, determining the display areas of the respective images based on the setting state of the screen area and the priorities, performing expansion, compression, and generation of the display image according to the corresponding display areas, and displaying the processed images in the corresponding areas, respectively.

As described above, the embodiments of the present invention have been described with reference to the music piece reproduction selection manipulation in reproducing the music. However, this is merely a detailed example using the technical features of the present invention, and the technical features of the present invention can be applied to diverse types of manipulations in various kinds of electronic devices such as image appliances, navigation devices, and the like, and particularly to devices having a multifunction of which the selection manipulation is complicated.

1. An information processing apparatus comprising an item selection device that selects, through a selection manipulation unit, an item from a plurality of items which are displayed in the form of a list and arranged in an arrangement direction, the item selection device including:
a manipulation detection unit that detects a state of a selection manipulation of the selection manipulation unit; and
a display area enlargement unit that enlarges a display area of the selected item in the arrangement direction when the manipulation detection unit detects that the selection manipulation of the selection manipulation unit is stopped.

2. The information processing apparatus as set forth in claim 1, wherein the selection manipulation unit is a rotary manipulation unit which selects an item by a rotating manipulation.

3. The information processing apparatus as set forth in claim 1, wherein the manipulation detection unit detects that the selection manipulation of the selection manipulation unit is stopped by a non-detection time of the selection manipulation in the selection manipulation unit.

4. The information processing apparatus as set forth in claim 1, further comprising a detailed information display unit that displays detailed information about the selected item on the display area of the selected item when the manipulation detection unit detects that the selection manipulation of the selection manipulation unit is stopped.

5. The information processing apparatus as set forth in claim 4, wherein the display area enlargement unit enlarges the display area of the selected item in accordance with the amount of the detailed information displayed by the detailed information display unit.

6. The information processing apparatus as set forth in claim 4, wherein the display area enlargement unit enlarges the display area of the selected item in accordance with the number of items of the detailed information displayed by the detailed information display unit.

7. The information processing apparatus as set forth in claim 4, wherein the display area enlargement unit selects whether to enlarge the display area of the selected item in accordance with a hierarchy of items of the detailed information displayed by the detailed information display unit.

8. The information processing apparatus as set forth in claim 1, further comprising a text size varying unit that varies a size of a text which is displayed on the display area of the selected item in accordance with a size of the display area of the selected item.

9. The information processing apparatus as set forth in claim 1, wherein the items are displayed such that display areas of the items gradually become smaller as it is getting out of the selected item.

10. The information processing apparatus as set forth in claim 1, further comprising a position display unit that displays position relationship of the selected item with respect to all of the items in the list.

11. The information processing apparatus as set forth in claim 1, wherein the items are displayed in a cyclic manner that first to n-th items are sequentially displayed by the selection manipulation of the selection manipulation unit, the n-th item is followed by the first item when the selection manipulation is in a forward direction, and the first item is followed by the n-th item when the selection manipulation is in a backward direction.

12. The information processing apparatus as set forth in claim 11, further comprising a boundary line display unit that displays a boundary line between the first item and the n-th item.

13. The information processing apparatus as set forth in claim 1, further comprising:
a selection decision unit that makes the selected item in a selection decided state;
an operation control unit that makes a controlled appliance in an operation state corresponding to selected item in the selection decided state;
a storage unit that stores the operation state of the controlled appliance;
a return manipulation unit that performs an instruction to make the controlled appliance return to the operation state stored in the storage unit; and
a return control unit that reads the operation state stored in the storage unit and makes the controlled appliance return to the operation state when the instruction is performed by the return manipulation unit.

14. The information processing apparatus as set forth in claim 1, further comprising:
an upper hierarchy display unit that displays an upper hierarchy item which are an item of an upper hierarchy;
a lower hierarchy display unit that displays lower hierarchy items which are items of a lower hierarchy corresponding to the upper hierarchy item displayed by the upper hierarchy display unit, as the items displayed in the form of the list; and
an upper hierarchy change detection unit that detects a changing manipulation for changing the upper hierarchy item,
wherein when the upper hierarchy change detection unit detects the changing manipulation, the upper hierarchy display unit displays the changed upper hierarchy item and the lower hierarchy display unit displays lower hierarchy items corresponding to the changed upper hierarchy item.

15. The information processing apparatus as set forth in claim 14, wherein the upper hierarchy change detection unit detects a slide manipulation of the selection manipulation unit.

16. The information processing apparatus as set forth in claim 15, wherein the upper hierarchy change detection unit includes:
a hierarchy movement manipulation detection unit that detects a direction of the slide manipulation of the selection manipulation unit; and
a hierarchy movement unit that moves hierarchy of the items displayed in the form of the list in accordance with the direction of the slide manipulation, detected by the hierarchy movement manipulation detection unit.

17. An audio apparatus comprising an item selection device that selects, through a selection manipulation unit, music piece information from a plurality of music piece information which are displayed in the form of a list and arrange in an arrangement direction, the selection device including:
a manipulation detection unit that detects a state of a selection manipulation of the selection manipulation unit; and
a display area enlargement unit that enlarges a display area of the selected music piece information in the arrangement direction when the manipulation detection unit detects that the selection manipulation of the selection manipulation unit is stopped.

18. The audio apparatus as set forth in claim 17, further comprising:
a decision manipulation detection unit that detects a decision manipulation which makes the selected music piece information in a selection decided state; and
a decided music piece reproduction unit that reproduces a music piece corresponding to the selected music piece information in the selection decided state.

19. The audio apparatus as set forth in claim 17, further comprising a selected music piece reproduction unit that reproduces a music piece corresponding to the selected music piece information.

20. The audio apparatus as set forth in claim 19,
wherein the selection manipulation unit is a rotary manipulation unit which selects music piece information by a rotating manipulation,
wherein the audio apparatus further comprises a rotating speed detection unit that detects a rotating speed of the rotating manipulation of the rotary manipulation unit, and
wherein when the rotating speed detected by the rotating speed detection unit is higher than a predetermined value, the selected music piece reproduction unit skips a predetermined number of music pieces.

21. The audio apparatus as set forth in claim 17, further comprising:
a music piece reproduction unit that reproduces a music piece; and
a music piece change detection unit that detects a change of the music piece being reproduced by the music piece reproduction unit,
wherein when the music piece change detection unit detects the change of the music piece being reproduced, music piece information corresponding to the music piece being reproduced is displayed in a manner of the selected music piece information.

22. The audio apparatus as set forth in claim 17, further comprising:
a reproduction history storing unit that stores reproduction history of music pieces; and
a historic order reproduction unit that reproduces the music pieces in the reproduction history stored in the reproduction history storing unit in a historic order from a music piece selected by the selection manipulation unit.

23. An item selection method for selecting, through a selection manipulation unit, an item from a plurality of items which are displayed in the form of a list and arranged in an arrangement direction, the item selection method comprising:
detecting a state of a selection manipulation of the selection manipulation unit; and
enlarging a display area of the selected item in the arrangement direction when detecting that the selection manipulation of the selection manipulation unit is stopped.
